(19) United States
(12) Patent Application Publication
(10) Pub. No.: US 2022/0401892 A1
(43) Pub. Date: Dec. 22, 2022

(54) A CERAMIC MEMBRANE FOR WATER AND WASTEWATER TREATMENT

(71) Applicant: National University of Singapore, Singapore (SG)

(72) Inventors: John Wang, Singapore (SG); Qilin Gu, Singapore (SG); How Yong Ng, Singapore (SG); Tze Chiang Albert Ng, Singapore (SG)

(21) Appl. No.: 17/626,649

(22) PCT Filed: Jun. 3, 2020
(86) PCT No.: PCT/SG2020/050321

§ 371 Date: Jan. 12, 2022

(30) Foreign Application Priority Data
Jul. 15, 2019 (SG) 10201906544Q

(51) Int. Cl. B01D 71/02; B01D 67/00; B01D 69/02

(52) U.S. Cl. CPC B01D 71/025; B01D 67/00411; B01D 69/02; B01D 71/027; B01D 2323/081; B01D 2323/50; B01D 2325/36; B01D 2325/02833; B01D 2325/02834

(57) ABSTRACT

Disclosed herein is a ceramic membrane for water and/or wastewater treatment, the membrane comprising a ceramic substrate having at least one surface and a membrane layer comprising core-shell particles on the at least one surface, where the core and shell are formed from materials described herein. The core of the core-shell particles is formed from one or more of the group selected from Al₂O₃ and ZrO₂, and the shell of the core-shell particles is formed from one or more of the group selected from SiO₂, TiO₂ and WO₃. In a preferred embodiment, the core is Al₂O₃ and the shell is SiO₂.

### FIELD OF INVENTION

This invention is on the development of the new composite-type ceramic membranes with desired surface properties, and improved performance for water and wastewater treatment.

### BACKGROUND

The listing or discussion of a prior-published document in this specification should not necessarily be taken as an acknowledgement that the document is part of the state of the art or is common general knowledge.

Membrane technology represents one of the most efficient and energy-saving processes in the separation, purification, water and wastewater treatments. In the application fields of water and wastewater treatment, ceramic membranes provide much better performance than their polymeric counterparts, owing to their intrinsically hydrophilic characteristics, chemical resistance and the long term mechanical stability. The filtration performance of ceramic membranes in water and wastewater treatment is largely determined by the physical and chemical characteristics of the top layer, such as the pore size, pore shape, level of porosity and membrane thickness. These properties of membrane surface are crucially important, which determine not only the permeability/selectively but also the fouling potential and long-term stability of the membrane.

In general, a hydrophilic membrane surface is highly desirable in order to improve the water permeability. In this regard, certain ceramic materials are generally superior to polymer materials, due to the intrinsically hydrophilic nature of inorganic compounds. Additionally, ceramic membranes show excellent mechanical stability, chemical resistance and longer lifespan. However, the widespread use of ceramic membranes in water and wastewater treatment is largely dependent on the cost and issues associated with the fouling of the membrane.

The high cost of ceramic membranes, such as Al₂O₃ ceramic membranes, mainly comes from the use of multiple fabrication steps and its sintering process at high temperatures. This results in the high processing cost and a high overall cost for the resulting commercial membranes. In an attempt to reduce the costs associated with the sintering step, appropriate sintering aids, such as SiO₂, MgO and CuO have been experimented to reduce the temperature required for the formation of the ceramic membranes. In addition, lower-cost and/or recycled materials have been explored as alternatives to prepare ceramic membranes.

Like any other membrane technology, ceramic membranes inevitably suffer from fouling issues, which not only deteriorate the filtration performance, but also increase the general maintenance cost and shorten the functional lifetime of the membrane. Therefore, there remains a need to develop ceramic membranes that has an extended operation lifetime and/or reduced costs associated with their manufacture.

Given that most of the foulants in surface water and wastewater are negatively charged, the fouling tendency can be minimized if the ceramic membrane surface is also negatively charged, taking advantage of the electrostatic repulsion effect between the membrane surface and the foulants. Unfortunately, the most widely used Al₂O₃ ceramic membranes possess a positively charged surface, and the negatively charged foulants could readily accumulate on the membrane surface by electrostatic attraction.

Surface modification is a strategy that has been used to improve ceramic membrane performance, aiming to improve the fouling resistance and thereby the overall cost of water/wastewater treatment. One approach is to introduce another continuous layer with desired properties (such as high hydrophilicity, negative charge, etc.) onto the surface of the ceramic membranes. Another related approach seeks to modify the ceramic grains near the surface of the ceramic membrane, rather than forming a continuous layer. Both approaches can tune the surface properties of the ceramic membrane. However, the post-modification process would inevitably reduce the surface pore size of the ceramic membranes, which would result in reduced water permeability and the overall filtration efficiency.

Therefore, there remains an urgent need to develop ceramic membranes with improved operation properties and methods of making the same.

### SUMMARY OF INVENTION

Aspects and embodiments of the invention are set out in the following clauses.

1. A ceramic membrane for water and/or wastewater treatment, the membrane comprising:
a ceramic substrate having at least one surface; and
a membrane layer comprising core-shell particles on the at least one surface, where the core is formed from:
an inorganic material with a positive zeta potential; and/or
an inorganic material that has a sintering temperature of from 800 to 2200° C. (e.g. 800 to 1500° C.), and

the shell is formed from:
an inorganic material having a negative zeta potential; and/or
an inorganic material with a sintering temperature of from 600 to 1400° C., provided that when the core is formed from an inorganic material that has a sintering temperature of 800 to 2200° C. (e.g. 800 to 1500° C.) and the shell is formed from an inorganic material with a sintering temperature of from 600 to 1400° C., the sintering temperature of the core is higher than the sintering temperature of the shell.

(e.g. the membrane may comprise:
a ceramic substrate having at least one surface; and
a membrane layer comprising core-shell particles on the at least one surface, where the core is formed from:
an inorganic material that includes one or more metal oxides with a positive zeta potential; and/or
an inorganic material that has a sintering temperature of 800 to 2200° C. (e.g. 800 to 1500° C.), and

the shell is formed from:
an inorganic material having a negative zeta potential; and/or
an inorganic material with a sintering temperature of from 600 to 1400° C., provided that when the core is formed from an inorganic material that has a sintering temperature of 800 to 2200° C. (e.g. 800 to 1500° C.) and the shell is formed from an inorganic material with a sintering temperature of from 600 to 1400° C., the sintering temperature of the core is higher than the sintering temperature of the shell).

2. The ceramic membrane according to claim 1, wherein the core of the core-shell particles is formed by one or more metal oxides with a positive zeta potential and/or a sintering temperature of from 800 to 2200° C. (e.g. 800 to 1500° C.).

3. The ceramic membrane according to claim 1 or claim 2, wherein the core of the core-shell particles is formed from one or more of the group selected from Al₂O₃ and ZrO₂, optionally wherein the core of the core-shell particles is formed from Al₂O₃.

4. The ceramic membrane according to any one of the preceding clauses, wherein the shell of the core-shell particles is formed from one or more of the group selected from SiO₂, TiO₂ and WO₃.

5. The ceramic membrane according to Clause 4, wherein the shell of the core-shell particles is formed from SiO₂.

6. The ceramic membrane according to any one of the preceding clauses, wherein the shell of the core-shell particles has an average thickness of from 1 to 50 nm, such as from 3 to 20 nm.

7. The ceramic membrane according to any one of the preceding clauses, wherein the core-shell particles have an average size of from 50 nm to 20 μm, such as from 100 to 500 nm.

8. The ceramic membrane according to any one of the preceding clauses, wherein the membrane layer has a thickness of from 3 to 50 μm, such as from 5 to 10 μm.

9. The ceramic membrane according to any one of the preceding clauses, wherein the membrane layer has a zeta potential of from −10 mV to −50 mV, such as from −20 to −30 mv, when measured in a medium having a pH of from 6 to 8.

10. The ceramic membrane according to any one of the preceding clauses, wherein:
(a) the ceramic membrane has a pure water flux of from 800 to 2500 LMH, such as from 1300 to 1600 LMH (e.g. from 1400 to 1600 LMH), when measured using a trans-membrane pressure of 100 kPa; and/or
(b) the water flux recovery ratio is greater than 70%, such as greater than 95% (e.g. with respect to BSA and/or SA); and/or
(c) the irreversible fouling of the ceramic membrane exposed to BSA and/or SA is less than 50%; and/or
(d) the substrate is formed from a ceramic material selected from one or more of the group selected from Al₂O₃, SiO₂, TiO₂ and WO₃; and/or
(e) the membrane has an average water contact angle of from 6° to 12°, such as 7° to 11°; and/or
(f) the membrane has a mean pore size for of from 60 to 250 nm, such as from 100 to 200 nm.

11. A core-shell particle comprising:
a core formed from:
   an inorganic material with a positive zeta potential; and/or
   an inorganic material that has a sintering temperature of 800 to 2200° C. (e.g. 800 to 1500° C.); and
a shell formed from:
   an inorganic material having a negative zeta potential; and/or
   an inorganic material with a sintering temperature of from 600 to 1400° C., wherein the core-shell particles have a zeta potential of from −10 mV to −50 mV, such as from −20 to −30 mv, when measured in a medium having a pH of from 6 to 8, provided that when the core is formed from an inorganic material that has a sintering temperature of 800 to 2200° C. (e.g. 800 to 1500° C.) and the shell is formed from an inorganic material with a sintering temperature of from 600 to 1400° C., the sintering temperature of the core is higher than the sintering temperature of the shell.

(e.g. the core-shell particle may comprise:
a core formed from:
   an inorganic material that includes one or more metal oxides with a positive zeta potential; and/or
   an inorganic material that has a sintering temperature of 800 to 2200° C. (e.g. 800 to 1500° C.); and
a shell formed from:
   an inorganic material having a negative zeta potential; and/or
   an inorganic material with a sintering temperature of from 600 to 1400° C., wherein the core-shell particles have a zeta potential of from −10 mV to −50 mV, such as from −20 to −30 my, when measured in a medium having a pH of from 6 to 8, provided that when the core is formed from an inorganic material that has a sintering temperature of 800 to 2200° C. (e.g. 800 to 1500° C.) and the shell is formed from an inorganic material with a sintering temperature of from 600 to 1400° C., the sintering temperature of the core is higher than the sintering temperature of the shell).

12. The core-shell particle according to Clause 11, wherein the core is formed from a metal oxide, optionally wherein the metal oxide is one or more of the group selected from SiC, more preferably, Al₂O₃, and ZrO₂ (e.g. the core is formed from Al₂O₃).

13. The core-shell particle according to Clause 11 or claim 12, wherein the shell is formed from one or more of the group selected from SiO₂, TiO₂ and WO₃, optionally wherein the shell is formed from SiO₂.

14. The core-shell particle according to any one of claims 11 to 13, wherein the shell of the core-shell particles has an average thickness of from 1 to 50 nm, such as from 3 to 20 nm.

15. The core-shell particle according to any one of Clauses 11 to 14, wherein the core-shell particles have an average size of from 50 nm to 20 μm, such as from 100 to 500 nm.

16. A method of using a ceramic membrane for water and/or wastewater treatment as described in any one of Clauses 1 to 10, which method comprises the steps of treating water or wastewater in a treatment system fitted with said ceramic membrane.

17. A method of manufacturing a ceramic membrane for water and/or wastewater treatment as described in any one of Clauses 1 to 10, comprising the steps of:
(i) providing a pre-sintered ceramic membrane comprising:
   a ceramic substrate having at least one surface; and
   a layer on the at least one surface comprising core-shell particles as described in any one of Clauses 11 to 15 and one or more polymeric additives; and
(ii) sintering the pre-sintered ceramic membrane at a suitable temperature for a period of time to remove the polymeric additive and provide the ceramic membrane.

18. The method according to Clause 17, wherein the pre-sintered ceramic membrane is formed by providing a ceramic substrate having at least one surface and coating the at least one surface with a mixture comprising one or more polymeric additives and core-shell particles as described in any one of Clauses 11 to 15, optionally wherein the coating is accomplished by one or more of spin-coating, dip-coating and spray coating (e.g. dip-coating and/or spin-coating).

### DRAWINGS

Certain embodiments of the present disclosure are described more fully hereinafter with reference to the accompanying drawings.

FIG. 1 Schematic illustration of the preparation process of (a) Al₂O₃©SiO₂ core-shell particles, and (b) Al₂O₃©SiO₂ core-shell structural ceramic membranes.

FIG. 2 Structural and composition characterization of the pristine Al₂O₃ particles and Al₂O₃©SiO₂ core-shell particles. (a) the thickness of SiO₂ layers, (b) XRD spectra, (c) FTIR spectra, and (d) TGA curve.

FIG. 3 Zeta potential of Al₂O₃©SiO₂ core-shell particles.

FIG. 4 Surface characterization of ceramic membranes. SEM image of (a) AS1150, (b-c) AS1250, (d) AS1300, (e) A1300, and (f) chemical composition of AS1250.

FIG. 5 Water contact angle of ceramic membranes.

FIG. 6 Intrinsic water transport properties of ceramic membranes prepared at different temperatures. (a) Pure water flux measured at 100 kPa, (b) viscosity*flux as a function of pressure, (c) hydraulic resistance and (d) pore size distribution.

FIG. 7 Antifouling properties of Al₂O₃ membranes prepared at 1300° C. and Al₂O₃©SiO₂ core-shell ceramic membranes prepared at 1250° C. (a) Flux recovery ratio against BSA and SA. Normalized water flux against (b) SA and (c) BSA. Reversible and irreversible membrane resistance (Rᵣ and Rᵢᵣ) identified for the membranes in (d) SA and (e) BSA.

FIG. 8 TEM images of (a) pristine Al₂O₃ particles after hydroxylation and (b-d) Al₂O₃©SiO₂ core-shell structure with different amounts of TEOS ethanolic solution: (b) Al₂O₃©SiO₂-1, (c) Al₂O₃©SiO₂-4, (d) Al₂O₃©SiO₂-16 and (e) SiO₂ nanoparticles detected as the secondary phase in Al₂O₃©SiO₂-16. The numerals on (c) and (d) represent the thickness of the SiO₂ shell.

FIG. 9 Chemical stability of Al₂O₃ and Al₂O₃©SiO₂ membranes in acid (HCl, 1M), neutral (H₂O) and basic (NaOH, 1M) aqueous solution.

FIG. 10 Characterization of the core-shell structured particles prepared with different amounts of TEOS ethanolic solution. TEM images of pure alumina (a), and core-shell particles: (b) 0.25 ml, (c) 0.5 ml, (d) 1.0 ml, and (e) 2.0 ml. (f) The SiO₂ thickness as a function of TEOS ethanolic solution content. (g) TGA curves of pure alumina and Al₂O₃©SiO₂ core-shell particles (1.0 ml).

FIG. 11 FTIR spectra of the core-shell structured particles prepared with different amounts of TEOS ethanolic solution added.

FIG. 12 Elemental analysis of the Al₂O₃©SiO₂ core-shell structured particles by 1D line-scanning and 2D mapping. (a) TEM image of an individual particle, (b) Elemental distribution of Al, O and Si along the line data 1 in (a), where a strong peak of Si element is observed at the edge.

FIG. 13 Zeta potential of Al₂O₃©SiO₂ core-shell particles.

FIG. 14 Surface and cross-sectional SEM images. (a-c) Alumina membranes, and (d-f) the Al₂O₃©SiO₂ membranes prepared at 1200° C. for 2 h.

FIG. 15 Surface properties of Al₂O₃ membranes and Al₂O₃©SiO₂ membranes. (a) Pore size distribution, (b) Water contact angle, and representative photograph of water contact angle of (c) Al₂O₃ membranes, and (d) Al₂O₃©SiO₂ membranes.

FIG. 16 Water permeability and antifouling properties. (a) PWF, (b) TMP dependent PWF, (c) filtration resistance, (d) the ratio of Rᵣ and Rᵢᵣ.

FIG. 17 FE-SEM image of (a) alumina powders (d₅₀=270 nm), and (b) commercial alumina ceramic membranes with an average grain size and an average pore size of 507±172 nm and 310 nm±181 nm, respectively.

FIG. 18 TEM images of core-shell particles prepared at a fixed TEOS/Al₂O₃ ratio of 0.6 ml/g (meaning 0.6 mL of TEOS per 1 g of Al₂O₃) with different mass scales. (a) Sample 1; (b) Sample 2; (c) Sample 3.

FIG. 19 The average thickness of SiO₂ layers of Al₂O₃©SiO₂ core-shell particles prepared at fixed TEOS/Al₂O₃ ratio of 0.6 ml/g with different mass scales. The results are obtained by measuring the thickness of the SiO₂ layer from more than 20 core-shell particles in the TEM image.

### DESCRIPTION

It has been surprisingly found that a ceramic membrane layer formed from inorganic core-shell particles can solve one or more of the problems identified above. Thus, in a first aspect of the invention, there is provided a ceramic membrane for water and/or wastewater treatment, the membrane comprising:
a ceramic substrate having at least one surface; and
a membrane layer comprising core-shell particles on the at least one surface, where the core is formed from:
an inorganic material with a positive zeta potential; and/or
an inorganic material that has a sintering temperature of from 800 to 2200° C. (e.g. 800 to 1500° C.), and

the shell is formed from:
an inorganic material having a negative zeta potential; and/or
an inorganic material with a sintering temperature of from 600 to 1400° C., provided that when the core is formed from an inorganic material that has a sintering temperature of 800 to 2200° C. (e.g. 800 to 1500° C.) and the shell is formed from an inorganic material with a sintering temperature of from 600 to 1400° C., the sintering temperature of the core is higher than the sintering temperature of the shell.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

As disclosed herein, the membranes disclosed herein have a high resistance to fouling, which off-sets at least part of the higher manufacturing costs associated with ceramic membranes. This is because the higher anti-fouling property will result in an extended membrane life-span, leading to a reduced water production cost, as more water can be produced over the extended lifetime of the membrane. This cost-saving may also be increased due to a lower maintenance cost and through the ability to significantly enlarging the filtration-backwashing cycle.

When used herein, the term “core-shell particle” refers to a first material that is covered by a second material. Thus, the first material forms the core and the second material forms the shell of the core-shell particle.

The core of the core-shell particle is formed from:
an inorganic material that includes one or more metal oxides with a positive zeta potential; and/or
an inorganic material that has a sintering temperature of 800 to 2200° C. (e.g. 800 to 1500° C.).

As will be appreciated, this core inorganic material may be:
a) formed only from an inorganic material with a positive zeta potential (e.g. the core is formed from one or more metal oxides with a positive zeta potential);
b) formed only from an inorganic material that has a sintering temperature of 800 to 2200° C. (e.g. 800 to 1500° C.), but which does not have a positive zeta potential;
c) formed from separate inorganic materials that comply with the requirements of (a) and (b) (i.e. a material that has a positive zeta potential and a further material that has a sintering temperature of from 800 to 2200° C. (e.g. 800 to 1500° C.)); or
d) formed from an inorganic material with a positive zeta potential and a sintering temperature of from 800 to 2200° C. (e.g. 800 to 1500° C.).

In embodiments of the invention that may be mentioned herein, the membrane may comprise:
a ceramic substrate having at least one surface; and
a membrane layer comprising core-shell particles on the at least one surface, where the core is formed from:
an inorganic material that includes one or more metal oxides with a positive zeta potential; and/or
an inorganic material that has a sintering temperature of 800 to 2200° C. (e.g. 800 to 1500° C.), and

the shell is formed from:
an inorganic material having a negative zeta potential; and/or
an inorganic material with a sintering temperature of from 600 to 1400° C., provided that when the core is formed from an inorganic material that has a sintering temperature of 800 to 2200° C. (e.g. 800 to 1500° C.) and the shell is formed from an inorganic material with a sintering temperature of from 600 to 1400° C., the sintering temperature of the core is higher than the sintering temperature of the shell.

When used herein, the term “an inorganic material that includes one or more metal oxides with a positive zeta potential” is intended to refer to an inorganic material that has a positive zeta potential and which may be a metal oxide or another inorganic material.

In this embodiment, the core of the core-shell particle may be formed from:
an inorganic material that includes one or more metal oxides with a positive zeta potential; and/or
an inorganic material that has a sintering temperature of 800 to 2200° C. (e.g. 800 to 1500° C.).

As will be appreciated, in this embodiment, the core inorganic material may be:
a) formed only from an inorganic material that includes one or more metal oxides with a positive zeta potential (e.g. the core is formed from one or more metal oxides with a positive zeta potential);
b) formed only from an inorganic material that has a sintering temperature of 800 to 2200° C. (e.g. 800 to 1500° C.), but which does not have a positive zeta potential;
(c) formed from separate inorganic materials that comply with the requirements of (a) and (b) (i.e. a material that includes one or metal oxides that has a positive zeta potential and a further material that has a sintering temperature of 800 to 2200° C. (e.g. 800 to 1500° C.)); or
d) formed from an inorganic material that includes one or more metal oxides with a positive zeta potential and a sintering temperature of 800 to 2200° C. (e.g. 800 to 1500° C.).

In embodiments of all of the above, the core of the core-shell particles may be one or more metal oxides having a positive zeta potential. Said materials may also display a sintering temperature of from 800 to 2200° C. (e.g. 800 to 1500° C.). Examples of metal oxides with a sintering temperature in the range of from 800 to 2200° C. (e.g. 800 to 1500° C.) include, but are not limited to Al₂O₃ and ZrO₂. Thus, in embodiments of the invention that may be mentioned herein, the core of the core-shell particles may be formed from one or more of Al₂O₃ and ZrO₂. In particular embodiments of the invention that may be mentioned herein, the core of the core-shell particles may be formed from Al₂O₃.

The shell of the core-shell particle is formed from:
an inorganic material having a negative zeta potential; and/or
an inorganic material with a sintering temperature of from 600 to 1400° C.

As will be appreciated, the shell inorganic material may be:
a) formed only from an inorganic material with a negative zeta potential;
b) formed only from an inorganic material that has a sintering temperature of 600 to 1400° C., but which does not have a negative zeta potential;
c) formed from separate inorganic materials that comply with the requirements of (a) and (b) (i.e. a material that has a negative zeta potential and a further material that has a sintering temperature of from 600 to 1400° C.); or
d) formed from an inorganic material with a negative zeta potential and a sintering temperature of from 600 to 1400° C.

In embodiments of the above, the shell of the core-shell particles may be a material having a negative zeta potential. Said materials may also display a sintering temperature of from 600 to 1400° C. Examples of materials with negative zeta potential and a sintering temperature in the range of from 600 to 1400° C. include, but are not limited to SiO₂, TiO₂ and WO₃. Thus, in embodiments of the invention that may be mentioned herein, the shell of the core-shell particles may be formed from one or more of SiO₂, TiO₂ and WO₃. In particular embodiments of the invention that may be mentioned herein, the core of the core-shell particles may be formed from SiO₂.

The shell on the core-shell particles may have any suitable thickness, provided that it is in the nano-range. For example, the shell may have a thickness of from 1 to 50 nm, such as from 3 to 20 nm. Other ranges that may be mentioned herein include from 9 to 13 nm.

For the avoidance of doubt, it is explicitly contemplated that where a number of numerical ranges related to the same feature are cited herein, that the endpoints for each range are intended to be combined in any order to provide further contemplated (and implicitly disclosed) ranges. Thus, in relation to the above related numerical ranges, there is disclosed:

a thickness of from 1 to 3 nm, from 1 to 9 nm, from 1 to 13 nm, from 1 to 20 nm, from 1 to 50 nm;

from 3 to 9 nm, from 3 to 13 nm, from 3 to 20 nm, from 3 to 50 nm;

from 9 to 13 nm, from 9 to 20 nm, from 9 to 50 nm;

from 13 to 20 nm, from 13 to 50 nm; and

from 20 to 50 nm.

As will be appreciated, it is preferred that the shell material has a lower sintering temperature than the core material. Without wishing to be bound by theory, it is believed that this provides two advantages to the ceramic membranes described herein. The first is that the core material does not leak out through the shell layer during the formation of the membrane. The second is that the shell material can be heated to a temperature that enables a good mechanical bond to be formed between it and the substrate surface. An advantage of this arrangement is that the particles used herein can undergo partial sintering at a lower temperature than is conventionally used, which is of great value for the low-cost and energy-efficient fabrication of ceramic membranes. Traditionally, in order to reduce the sintering temperature of ceramic membranes, the most widely adopted strategy is the incorporation of sintering aids into the ceramic matrix, where the inhomogeneous distribution of sintering aids negatively affects the final product's performance.

The core-shell particles can have any suitable size. For example, they can have a size in the range of from 50 nm to 20 μm, such as from 100 to 500 nm. The larger-sized particles (above 500 nm) may be used to form the whole or part of the substrate, while the smaller particles (below 500 nm, such as from 50 to 500 nm, such as from 100 to 400 nm) may be used to form the membrane layer.

References to the average size of the particles are intended to be a reference to the average diameter of said nanoparticles.

The membrane layer is formed on top of the substrate material and may have any suitable thickness, provided that it is thick enough to provide the desired effects. This can be determined readily by a skilled person familiar with this field. Examples of suitable thicknesses that may be mentioned herein for the membrane layer include from 3 to 50 μm, such as from 4 to 10 μm, such as 5.5. μm.

As the shell material coats the core material, when the shell material has a negative zeta potential, the resulting membrane layer also has a negative zeta potential. Any suitable negative zeta potential may result from the use of inorganic materials having a negative zeta potential as the shell material. For example, the membrane layer may have a zeta potential of from −10 mV to −50 mV, such as from −20 to −30 mv, when measured in a medium having a pH of from 6 to 8.

The ceramic membranes disclosed herein may be hydrophilic and therefore have a lower water contact angle than is conventional. For example, the membrane may have an average water contact angle of from 6° to 12°, such as 7° to 11°, as measured by the method described in the examples below.

The ceramic membranes disclosed herein may be different from the materials formed from a single material, such as alumina. For example, the membrane may have a mean pore size of from 60 to 250 nm, such as from 100 to 200 nm. Without wishing to be bound by theory, it is believed that the mean pore size is influenced by the size of the particles that are used to form the membrane layer (i.e. the pore size in the membrane layer is proportionally correlated to the particle size according to a closely-packed structure). It is also noted that the membrane layer is directly formed upon the substrate and does not need to undergo surface modification after it has been formed. Such post-surface modification after formation will reduce the surface pore size and reduce water permeability. Thus, the ceramic membranes described herein do not need to undergo post-surface modification after formation, thereby increasing their water permeability relative to other membranes that undergo such post-surface modifications. Without wishing to be bound by theory, this may also result in the increased stability (and hence lifespan) of the membranes of the current invention.

The currently disclosed ceramic membranes may provide a pure water flux of from 800 to 2500 LMH, such as from 1300 to 1600 LMH (e.g. from 1400 to 1600 LMH), when measured using a trans-membrane pressure of 100 kPa.

The currently disclosed ceramic membranes may also be more resistant to fouling than conventional ceramic membranes. For example, the water flux recovery ratio for the ceramic membranes disclosed herein may be greater than 70%, such as greater than 95% (e.g. with respect to BSA and/or SA). This can be in a static adsorption experiment in a BSA and/or SA solution, as described in more detail hereinbelow. Additionally, the ceramic membranes described herein may display superior antifouling properties. For example, the irreversible fouling of the ceramic membranes disclosed herein may be less than 50% when exposed to BSA and/or SA.

Any suitable substrate may be used for the ceramic membranes disclosed herein. For example, the substrate may be formed from a ceramic material selected from one or more of the group selected from Al₂O₃, SiO₂ and TiO₂. These powders used to prepare the substrates are usually large in size (several tens of micrometers), and a high sintering temperature is required. The core-shell concept proposed in this work is applicable to prepare the substrate. Namely, the coarse powders can be coated with the materials owning a relatively lower sintering temperature prior to the sintering process.

Also disclosed herein are core-shell particles that are used to form the membrane layer of the ceramic membrane. Thus, there is also disclosed a core-shell particle comprising:

a core formed from:
an inorganic material with a positive zeta potential; and/or
an inorganic material that has a sintering temperature of from 800 to 1500° C., and the shell is formed from:
an inorganic material having a negative zeta potential; and/or
an inorganic material with a sintering temperature of from 600 to 1400° C., provided that when the core is formed from an inorganic material that has a sintering temperature of 800 to 1500° C. and the shell is formed from an inorganic material with a sintering temperature of from 600 to 1400° C., the sintering temperature of the core is higher than the sintering temperature of the shell.

In additional or alternative embodiments of this aspect of the invention, there is also provided a core-shell particle comprising:
a core formed from:
   an inorganic material that includes one or more metal oxides with a positive zeta potential; and/or
   an inorganic material that has a sintering temperature of 800 to 1500° C.; and
a shell formed from:
   an inorganic material having a negative zeta potential; and/or
   an inorganic material with a sintering temperature of from 600 to 1400° C., wherein the core-shell particles have a zeta potential of from −10 mV to −50 mV, such as from −20 to −30 mv, when measured in a medium having a pH of from 6 to 8, provided that when the core is formed from an inorganic material that has a sintering temperature of 800 to 1500° C. and the shell is formed from an inorganic material with a sintering temperature of from 600 to 1400° C., the sintering temperature of the core is higher than the sintering temperature of the shell.

These materials have been described in depth above and the definitions and embodiments hereinbefore also apply to these core-shell particles per se. Hence, they will not be described in detail again for the sake of brevity.

As will be appreciated, the ceramic membranes described herein are particularly suited for use in the treatment of water, wastewater or both. Thus, there is also disclosed herein a method of using a ceramic membrane for water and/or wastewater treatment as described hereinbefore, which method comprises the steps of treating water or wastewater in a treatment system fitted with the said ceramic membrane. Further details of the methods that may be applied are described in the Examples section hereinbelow.

There is also described a method of manufacturing a ceramic membrane for water and/or wastewater treatment as described hereinbefore, comprising the steps of:
(i) providing a pre-sintered ceramic membrane comprising:
   a ceramic substrate having at least one surface; and
   a layer on the at least one surface comprising core-shell particles as described hereinbefore and one or more polymeric materials; and
(ii) sintering the pre-sintered ceramic membrane at a suitable temperature for a period of time to remove the polymeric material and provide the ceramic membrane.

In embodiments of the invention, the pre-sintered ceramic membrane may be formed by providing a ceramic substrate having at least one surface and coating the at least one surface with a mixture comprising one or more polymers and core-shell particles as described hereinbefore, optionally wherein the coating is accomplished by dip-coating and/or spray coating.

Any suitable polymeric additive may be used in the method described above, provided that it can act as a binder, so that the core-shell nanoparticles are affixed to the surface of the substrate before sintering. As will be appreciated, the main requirement is that the polymeric additives can be burned off at a temperature below the sintering temperature of the shell component of the core-shell materials described herein. A secondary property that may be useful, is that when the mixture comprising the core-shell nanoparticles and the one or more polymeric additives is to be applied by one or more of spin-coating, dip-coating and/or spray-coating (rather than in the form of a neat melt-blend), then the polymeric additives should be soluble in the solvent used. In embodiments of the invention that may be mentioned herein, the method may be selected from dip-coating and/or spray coating. An example of a suitable polymeric additive that may be mentioned herein is polyvinyl alcohol (PVA).

The core-shell nanoparticles used herein may be formed by any suitable method. For example, the core-shell nanoparticles may be formed by exposing an activated core particle (e.g. a core particle with a positive zeta potential) to a solution containing a shell precursor solution. For example, the core particles may be Al₂O₃ nanoparticles that have been exposed to NaOH solution to enrich their surface with hydroxyl groups. The shell precursor solution may be tetraethyl orthosilicate (TEOS) or tetramethyl orthosilicate (TMOS) in ethanol. Further details regarding the formation of the core-shell nanoparticles may be found in the experimental section below, which may be modified as required by analogy across the scope of the invention.

The ceramic substrate may be formed by any conventional method in the art. The ceramic substrate may be formed by the materials mentioned hereinbefore.

The ceramic membranes described herein have an improved overall pore structure and membrane surface, such that water permeability is not adversely affected and the fouling behavior is improved.

Further aspects and embodiments of the invention will now be described by reference to the following non-limiting examples.

### EXAMPLES

Described herein is a novel engineering strategy to obtain a negatively charged surface of ceramic membranes based on core-shell structured particles, which can be effectively integrated into the typical preparation process of ceramic membranes. Core-shell structure is a well-established concept in developing various nanomaterials, aiming at deriving a new functionality or/and improving the stability by taking the advantages of the synergistic effect among different components. It is thus believed that a properly engineered core-shell structure would change the surface characteristics, as well as the overall chemical and physical properties of ceramic membranes. It is believed that this is the first time in which ceramic membranes based on core-shell structural powders were prepared.

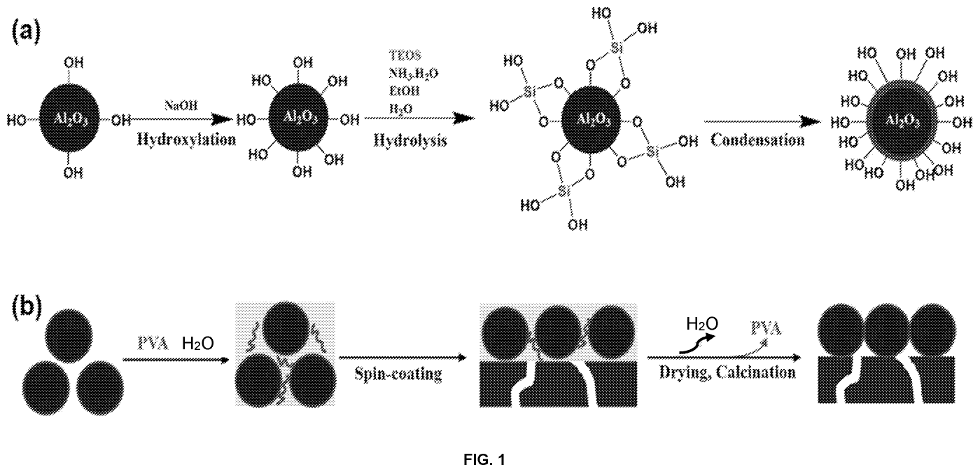

As an example, negatively charged SiO₂ shells with several nanometers in thickness were coated on positively charged Al₂O₃ cores, and the core-shell structured particles were then assembled on the ceramic substrate, as illustrated in FIG. 1. The amorphous SiO₂ layers helped lower the sintering temperature and maintain the high porosity compared with the pure Al₂O₃ membranes. Together with the negative charged and hydrophilic nature of SiO₂ shells, the membranes with Al₂O₃©SiO₂ core-shell structured top layer showed improved water flux and fouling resistance.

Compared to organosilanes and carbon-based materials, metal or metalloid oxides such as SiO₂ are superior for surface modification of ceramic membranes, in terms of the stability and interfacial adhesion. Among the metal oxides, the isoelectronic point (IEP) of TiO₂ and SiO₂ is relatively low (less than 4.0), thereby they are negatively charged in a wide pH range.

Materials and Method

The chemicals including alumina powders (α-Al₂O₃, 300 nm, 99.9%, US Research Nanomaterials Inc.), tetraethoxysilane (TEOS, C₈H₂₀O₄Si, 98%, Fluka), sodium hydroxide pellets (NaOH, >97%, Sigma-Aldrich), ethanol (C₂H₅OH, 99%, Sigma-Aldrich) and polyvinyl alcohol (PVA, Mw=72000, Fluka), ammonia solution (NH₄.OH, 28-30%, Merck) were used as received without further purification.

### Example 1: Preparation of Al₂O₃©SiO₂ Hybrid Particles

Hydrophilic and negatively charged SiO₂ was coated on crystalline α-Al₂O₃ powders. The preparation process of the Al₂O₃©SiO₂ core-shell structure is schematically illustrated in FIG. 1A. The commercial α-Al₂O₃ particles with an average size of 300 nm were first treated in NaOH solution (1 M) to enrich the surface with hydroxyl groups, since the surface hydroxyl groups are known to coordinate with Si precursors. After the functionalization, the BET surface area of the Al₂O₃ powders was slightly increased from 3.7 m²/g to 4.6 m²/g. To fine-tune the thickness of the SiO₂ shell, tetraethyl orthosilicate (TEOS) with a lower Si content (13.4 wt %) rather than tetramethyl orthosilicate (TMOS, Si=18.4%) was chosen as the Si precursor. The SiO₂ shells are formed on the surface of Al₂O₃ particles through in-situ hydrolysis/condensation reaction in the weakly basic solution.

A thin SiO₂ layer is proposed to form on the sub-micro Al₂O₃ particles, which could minimize the effect on the package density and porosity of the derived membranes. To confirm the successful coating of SiO₂ onto Al₂O₃ particles, the samples prepared with different amounts of TEOS ethanolic solution (denoted as Al₂O₃©SiO₂-x, x=1, 2, 4, 8, 16) were systematically characterized by using TEM, XRD, FTIR and TGA.

Experimental

Alumina powders (1.0 g) were first treated in NaOH solution (40 ml, 1.0 M) under stirring for 5 h. The treated Al₂O₃ powders with abundant hydroxyl groups on the surface were collected by centrifugation at 5000 rpm for 5 min. Then, 40 ml DI water was added to disperse the functionalized alumina powder accompanying with ultrasonic treatment (42 kHz, 10 min). Ethanol (34 ml) and ammonia solution (30 wt %, 6 ml) were mixed first, and then added into the above suspension, followed by a continuous stirring at 40° C. for 10 min. Different volumes (x=1, 2, 4, 8, 16 ml) of TEOS ethanolic solution (15 vol %) was then added drop-wisely into the obtained alumina suspension. Followed by continuous stirring at room temperature for 12 h, the white precipitates were separated through the centrifugation and further washed with DI water repeatedly until the pH value reached around 7. After drying at 80° C. for 24 h, the Al₂O₃©SiO₂ core-shell structured powders were ready for characterization and subsequent membrane preparation. The samples prepared with different volumes of TEOS ethanolic solutions were denoted as Al₂O₃©SiO₂-x (x=1, 2, 4, 8, 16).

TEM

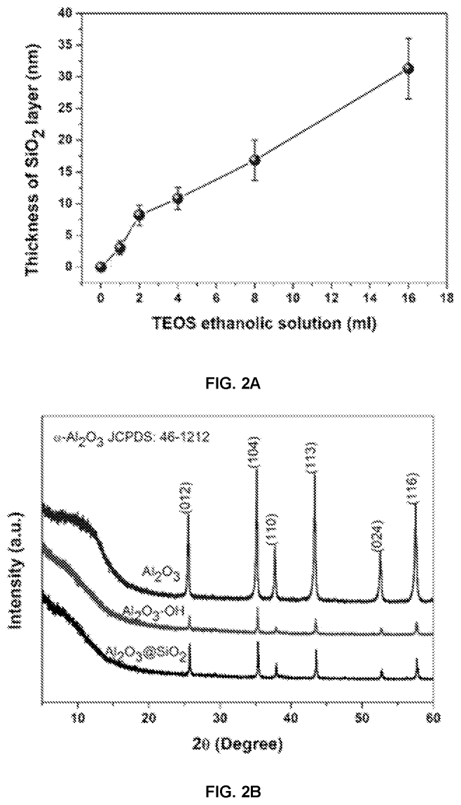

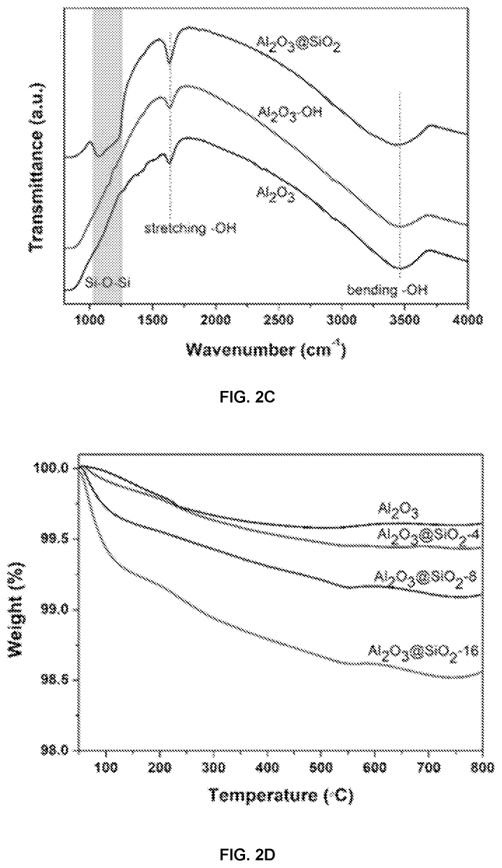

The addition of TEOS ethanolic solution results in the formation of SiO₂ layers, as shown by the TEM images in FIG. 8. The thickness of the SiO₂ shell can be tuned from several nanometers to tens of nanometers by adjusting the content of TEOS added (FIG. 2A). When the amount of added TEOS is more than 0.5 ml, the thickness of the SiO₂ shell increases almost linearly with the TEOS content.

From the TEM images, some free-standing SiO₂ nanoparticles were observed in the samples prepared at high TEOS content, as shown in FIG. 8E.

XRD

XRD patterns were acquired using an X-ray powder diffraction Bruker D8 diffractor operating at 40 kV and 40 mA using Cu K radiation (0.15406 nm).

XRD patterns of the Al₂O₃©SiO₂ particles (Al₂O₃©SiO₂-4 sample) are similar to that of pristine Al₂O₃ powders (FIG. 2B) except for the relatively weak intensity, indicating the amorphous state of the formed SiO₂ shells. Similar results were reported by Son and co-workers in the synthesis of SiO₂©TiO₂, where a broad band centered at 2θ=22° attributing to SiO₂ amorphous phase was observed even after calcination at 600° C. In contrast, the difference between the pure Al₂O₃ and Al₂O₃©SiO₂ core-shell is reflected in the FT-IR spectra and TGA results.

FT-IR

Fourier-transform infrared (FT-IR) spectra were acquired using an FT-IR spectrophotometer (NEXUS670, Nicollet, USA) to analyze the surface condition of the as-obtained Al₂O₃©SiO₂-4 sample.

From FT-IR spectra in FIG. 2C, both the pristine and pre-treated Al₂O₃ powders show two strong peaks centered at 1633 and 3473 cm⁻¹, ascribing to the stretching and bending —OH vibrations, respectively. The results confirm the existence of abundant surface hydroxyl groups. In addition, a wide peak located at around 1085 cm⁻¹ originating from the Si—O—Si stretching vibrations is observed in the Al₂O₃©SiO₂ samples.

TGA

The thermal behavior of the samples was analyzed thermogravimetric analysis (TGA) in air from room temperature to 800° C. with a ramping rate of 10° C./min.

From FIG. 2D, the pre-treated samples show a larger weight loss compared with that of the pristine Al₂O₃ powders, confirming an increasing amount of surface hydroxyl groups. With the increase in TEOS content, the weight loss of Al₂O₃©SiO₂ samples increases gradually. These results suggest an increasing content of largely amorphous SiO₂, since the hydrophilic SiO₂ would enhance the adsorption of water molecules.

XPS

The surface chemistry of the high-yielding Al₂O₃©SiO₂ core-shell particles was then examined by XPS (Kratos Analytical Axis UltraDLD UHV).

Pristine Al₂O₃ powders have a chemical composition of 61.76% O and 38.24% Al, while the pre-treated samples (Al₂O₃©SiO₂-4) have an atomic content of 18.03% for Si 2p, 56.50% for O and 25.47% for Al, indicating the successful SiO₂ deposition on the Al₂O₃ surface. The chemical bonds between Al₂O₃ cores and SiO₂ shells are demonstrated by the high-resolution XPS of O 1s spectra (not shown). Due to the larger electronegativity of Si than that of Al, the binding energy of the Si—O bond is stronger than that of the Al—O bond, resulting in a slight shift of binder energy to higher level. Also, there is an additional peak in Al₂O₃©SiO₂ core-shell structure with higher binding energy (532.06 eV), corresponding to the Si—O—Si bond. Significantly, the peaks attributed to Al—O—Al bond (530.59 eV) in pristine Al₂O₃ slightly shifts to a higher binding energy of 530.96 eV with the content being reduced from 57.04 atm % to 13.73 atm %. Note that peaks in pristine Al₂O₃ powders has 57.04 atm % Al—O—Al bond and 42.96 atm % OH bond, while the pre-treated samples have 62.53 atm % Si—O—Si bond, 13.73 atm % Al—O—Al bond and 23.74 atm % OH bond.

Zeta Potential

The zeta potential of the Al₂O₃©SiO₂ powders (specifically Al₂O₃©SiO₂-4) were measured based on the Smulochowski model by zetasizer (Nanobook).

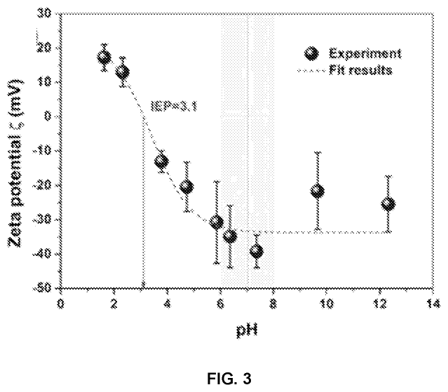

Based on zeta potential measured at different pH values (FIG. 3), the isoelectric point (IEP) of Al₂O₃©SiO₂ core-shell particles is determined to be ˜3.1, which is close to the value reported for amorphous SiO₂ (IEP=2.2-4.0). Notably, the zeta potential in the pH range of 6.0-8.0 is strongly negative (˜−35 mV), indicating their great potential to construct the negatively charged membrane surface. The result also confirms the desired coverage of SiO₂ nanolayer on the surface of Al₂O₃ particles, which is crucial for the subsequent formation of the complete SiO₂ membrane surface. These results confirm the formation of strong Al—O—Si bonds at the interfaces and the change of surface charge from positive for Al₂O₃ to negative for Al₂O₃©SiO₂ core-shell structure.

### Example 2: Preparation and Characterization of Al₂O₃©SiO₂ Core-Shell Structured Membranes

As illustrated in FIG. 1B, the Al₂O₃©SiO₂ core-shell structured membranes was prepared by dispersing the ceramic powders as synthesized in Example 1 in water with the addition of PVA as a binder to form a milky slurry, which was then spin-coated on commercial ceramic membranes followed by natural drying at room temperature for 24 h.

Experimental

0.5 g of Al₂O₃©SiO₂ powders (Al₂O₃©SiO₂-4 prepared in accordance with Example 1) were dispersed into 2.5 ml of DI water with a mass loading of 20% by ultrasonic treatment for 10 min. Then, an identical volume of PVA aqueous solution (10 wt %) was added into the suspension followed by continuous stirring for 12 h. The obtained slurry was then coated onto the commercial microfiltration ceramic membranes (Al₂O₃, pore size: ˜100 nm; commercial, e.g., Nanjing Shuyihui Scientific Instruments CO., LTD) by spin-coating (3000 rpm, 60 s). The samples were first dried at room temperature for 24 h and then sintered at different temperature (denoted as AS-T) for 2 h with a ramping rate of 1° C./min. Pure Al₂O₃ membranes were prepared using the pristine Al₂O₃ powders in the same condition (denoted as A-T). For example, AS1150 represents a sample coated with Al₂O₃©SiO₂ powders and sintered at 1150° C. for 2 h.

Sintering Temperature

Compared to the pure Al₂O₃ suspension, the Al₂O₃©SiO₂ suspension shows better dispersibility, stability and uniformity, thus forming a smooth layer on the ceramic substrate. Amorphous SiO₂ can be condensed at a temperature above 400° C., and the binder PVA can be completely burned out above 500° C. Therefore, the optimized sintering temperature of Al₂O₃©SiO₂ membranes was explored above 500° C.

It is found that the Al₂O₃©SiO₂ membranes prepared at 1150° C. (AS-1150) show good mechanical stability. Specifically, the surface layer is well-bonded to the substrate. In contrast, a temperature of above 1300° C. is required to ensure the strong adhesion between pure Al₂O₃ powders and the ceramic substrate. Otherwise, the pure Al₂O₃ surface layers can easily peel off from the substrate. The results indicate that the SiO₂ layers on the Al₂O₃ surface promote the partial sintering at a lower temperature, which is of great value for the low-cost and energy-efficient fabrication of ceramic membranes. Traditionally, in order to reduce the sintering temperature of ceramic membranes, the most widely adopted strategy is the incorporation of sintering aids into the ceramic matrix. However, this results in an inhomogeneous distribution of sintering aids which would in turn negatively affect the final products.

SEM

The morphology and chemical composition of the samples were determined using an SEM (SUPRA 40 ZEISS, Germany) with the EDS attachment. Each sample was pretreated by gold sputtering (60s, 20 mA) prior to the observation.

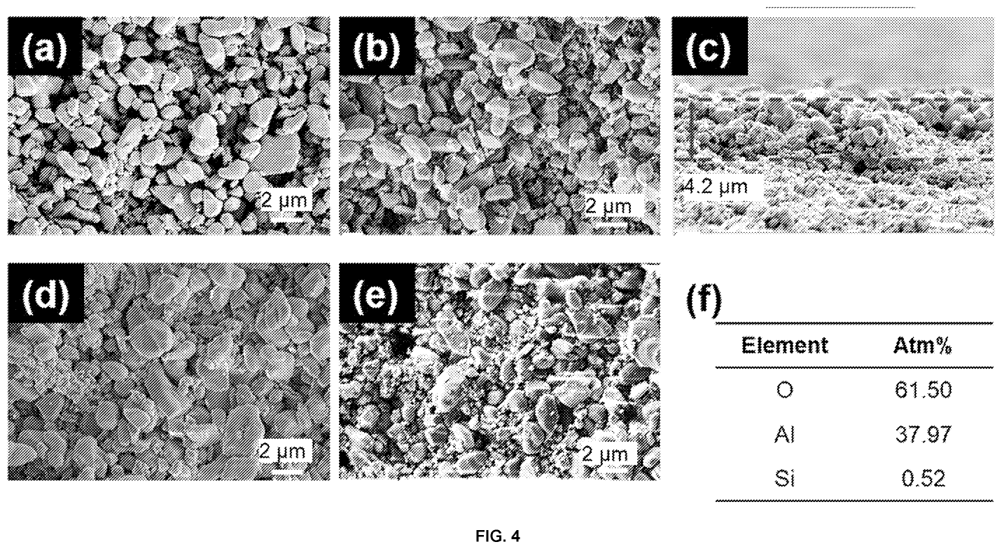

FIG. 4A-E shows the SEM images of Al₂O₃©SiO₂ membranes prepared at different temperatures. The membrane surface of alumina membranes and Al₂O₃©SiO₂ membranes presents a similar microstructure to the un-sintered powders, where the particle size is a slightly bimodal distribution, namely both large-sized particles and smaller sized particles are observed (FIG. 4A-E). There thus forms the dual-scaled pore structure, which would enhance the porosity and specific surface area of the membranes. The thickness of the top layer was measured to be ˜4.2 μm (FIG. 4C). The relatively thin top layer would minimize the membrane resistance and increase the permeability of membranes.

EDS

From characterization by using EDS accessory that connected to SEM, the signal of Si was detected in the Al₂O₃©SiO₂ membranes sintered at 1250° C., as shown in FIG. 4F.

Water Contact Angle

The water contact angle was measured with a VCA Optima surface analysis system (Advanced Surface Technology, Billerica, Mass.) using a water droplet (1.5 μL) as an indicator.

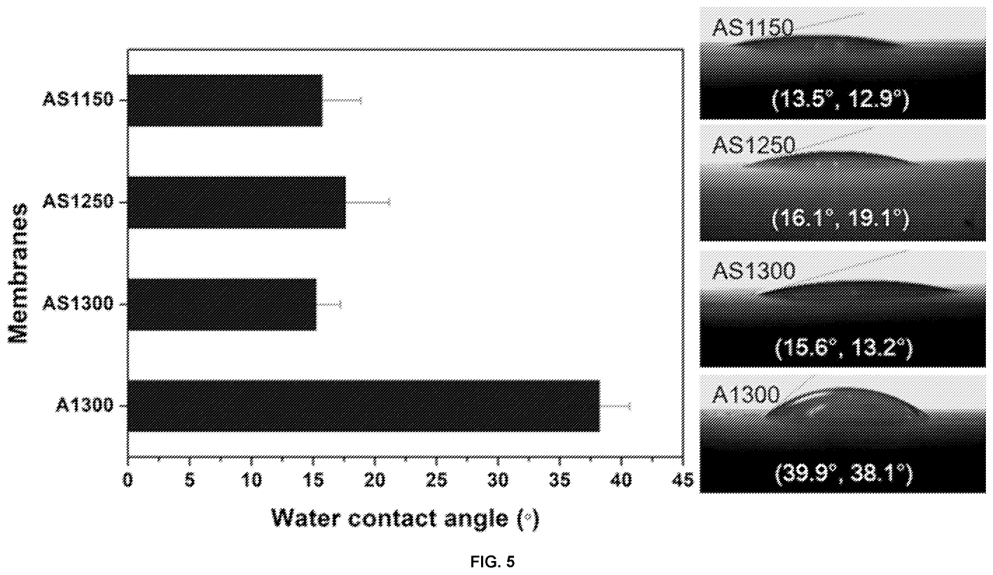

The surface hydrophilicity of Al₂O₃©SiO₂ core-shell membranes is greatly improved compared with the Al₂O₃ membranes. As shown in FIG. 5, the Al₂O₃ membranes present a hydrophilic surface with a water contact angle of ˜37°. Notably, the water contact angle of membranes composed of Al₂O₃©SiO₂ core-shell structure was reduced to around 15°. Without wishing to be bound by theory, it is believed that the improved hydrophilicity mainly originates from the more hydrophilic SiO₂ layers.

Chemical Stability

The stability tests were conducted by immersing the alumina membrane prepared at 1300° C. and Al₂O₃©SiO₂ core-shell membrane sintered at 1250° C. in various solutions including acidic solution (HCl, 1 mol/L), neutral DI water and base solution (NaOH, 1 mol/L). After 120 h, the samples were taken out and gently washed with DI water, followed by drying at 110° C. for 12 h. The mass of samples before and after the treatment was recorded, and the mass loss was used to evaluate the stability of these ceramic membranes.

Although pure SiO₂ membranes with hydrophilic characterization had also been studied, their poor chemical stability in the presence of a humid atmosphere or water vapor limited their application in water and wastewater treatment. In contrast, the Al₂O₃©SiO₂ core-shell structured membranes show good stability in water for 120 h, and chemical stability comparable to that of Al₂O₃ membranes in acid and basic solution (FIG. 9).

### Example 3: Water Permeability and Membrane Resistance of the Ceramic Membranes

The water permeability of the ceramic membranes as produced in Example 2 was measured. Pore size distribution was measured to explain the water permeability results.

Pure Water Flux and Membrane Resistance Tests

Water permeation was conducted by a home-made dead-end filtration setup, in which the cell for ceramic membrane pieces allowed for a single active side of the membrane to be tested.

MilliQ water used in the tests was pre-treated through a 0.02 μm filter to remove any possible colloidal particles, which is referred to Pure Water hereafter. The diameter of the active filtration area was 16 mm and a constant pressure of 100 kPa was applied. The weight of permeate and the corresponding permeation time were recorded to calculate water flux. Permeation flux (J, L˜m⁻²·h⁻¹) was calculated from

$$J = \frac{V}{A t}$$

where V (L) is the permeate volume, and t (h) is the operation time. The pure water permeability can be evaluated by the intrinsic membrane resistance, Rₘ (m⁻¹), which are defined as

$${R}_{m} = \frac{Δ PAt}{μ V}$$

where ΔP is the trans-membrane pressure (Pa), A is the effective surface area of the membrane (m²), t is the filtration time (s), μ is the kinematic viscosity of water (1×10⁻³ Pa·s) and V is the volume of water flowing through the membranes.

Pore Size Distribution

The pore size distribution was measured by using a capillary flow porometer (Porometer 3G, Quantachrome Instruments, USA). Firstly, the ceramic membranes with a diameter of 25 mm were placed in the sample holder. Then, the sample was wetted by the wetting fluids (Porofil) with low surface tension and vapor pressure. The gas flow passes through the wet sample with the increasing pressure was recorded. After that, the pressure-dependent gas flow of the dry sample was measured. Finally, the pore size distribution of the sample was automatically converted from the gas flow of the wet and dry run.

Results

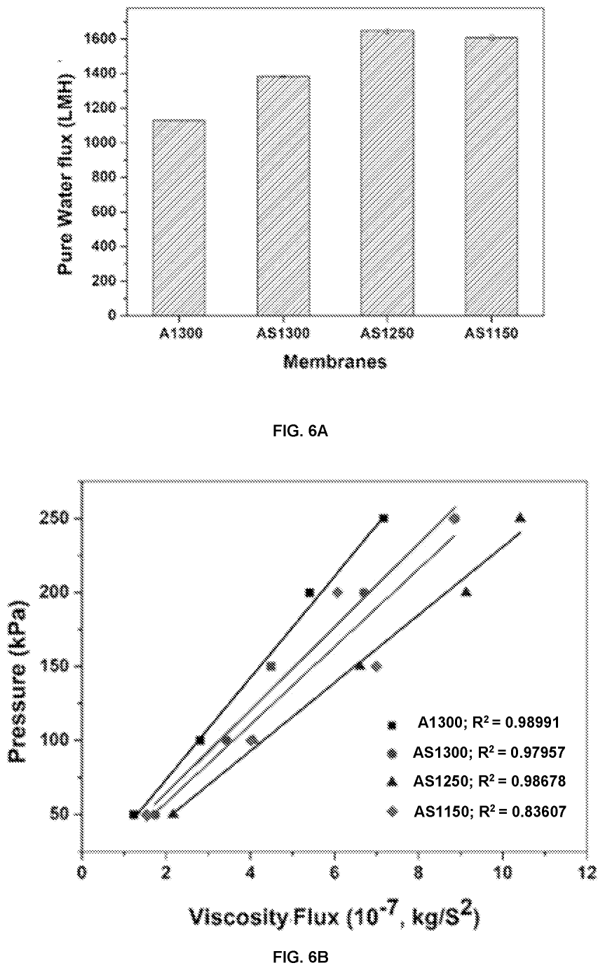

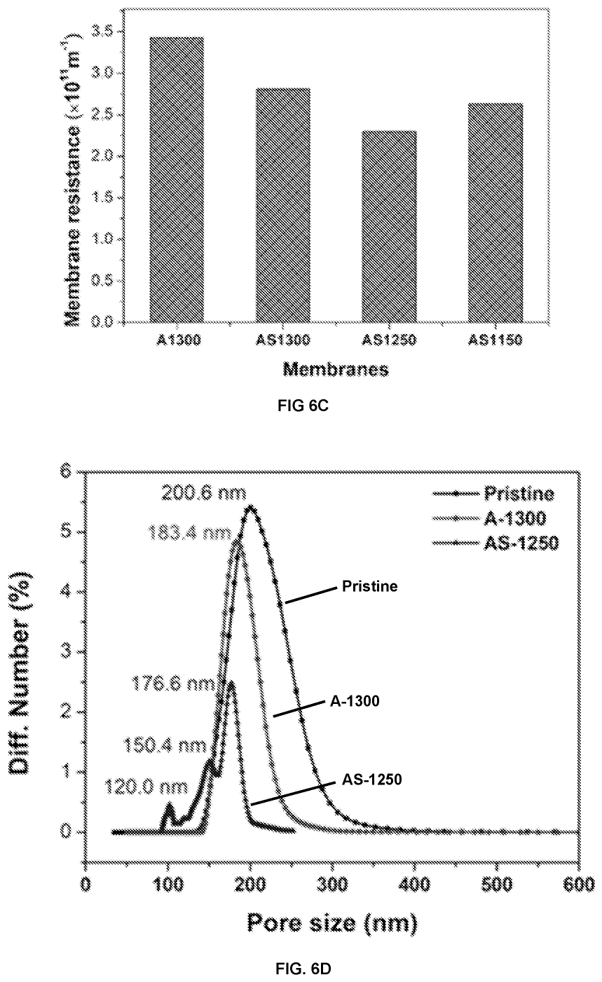

The water permeability of ceramic membranes was measured at a trans-membrane pressure (TMP) of 100 kPa. Compared with the pure Al₂O₃ membranes, the Al₂O₃©SiO₂ membranes show higher pure water flux, as shown in FIG. 6A. The increment is attributed to the improved hydrophilicity and well-maintained pore structure. In particular, the Al₂O₃©SiO₂ membranes prepared at 1250° C. (AS1250) show the highest pure water flux.

Their intrinsic water transport properties were further evaluated by measuring the pure water flux at different TMPs. Membrane resistance referring to the ease of water transport through the active layer of the membrane was tested. A higher resistance either requires a higher operating pressure or results in lower throughput, both of which are undesirable in practical application. FIG. 6B shows the pure water flux as a function of pressure with the viscosity into consideration. The slope of the linear fitting curve represents the hydraulic resistance of the membrane. As plotted in FIG. 6C, the pure Al₂O₃ membranes show the highest membrane resistance, while the Al₂O₃©SiO₂ membrane prepared at 1250° C. shows the best water transport properties with the lowest membrane resistance.

In order to understand the improved water permeability of the Al₂O₃©SiO₂ core-shell membranes, the pore size distribution (PSD) was measured. For comparison, the PSD of Al₂O₃ membranes prepared at 1300° C. was also plotted in FIG. 6D. The coating of Al₂O₃ top layers slightly reduced the average pore size from 200.6 nm to 183.4 nm with a narrower of pore size distribution, where the amount of relatively large pores was greatly reduced while the small pores were hardly affected. In contrast, the average pore size of Al₂O₃©SiO₂ core-shell membranes was reduced to 176.6 nm, accompanying with some more small pores around 150.4 and 120.0 nm. The relatively small pores and multiple peak distribution of Al₂O₃©SiO₂ membranes are attributed to the improved sintering activity of Al₂O₃©SiO₂ particles. In general, surface hydrophilicity and porosity would promote the permeability of membranes. Therefore, it can be inferred that the enhanced permeability of the core-shell membranes is mainly related to the improved surface hydrophilicity rather than the porosity.

### Example 4: Anti-Organic Fouling Properties

Organic foulants were allowed to naturally develop on the ceramic membranes prepared in Example 2 under static conditions to determine the innate fouling propensity of the modified surfaces. Sodium alginate (SA) and bovine serum albumin (BSA) were used as the model compounds for polysaccharides and proteins, respectively.

Experimental

A1300 and AS1250 were selected as the Al₂O₃ membrane and Al₂O₃©SiO₂ core-shell ceramic membrane, respectively. The pure water flux (J₀) of the virgin membranes was measured in accordance with the procedure in Example 3, and membrane pieces with the dimension of 25 mm×25 mm were suspended at mid-height in 50 mg/L of the organic solution (BSA or SA) under constant stirring at 100 rpm for 24 h. These membrane pieces were then gently washed with 1 mL of pure water per square centimeter of membrane surface thrice to remove any loosely bound particles. The pure water flux (J₁) of fouled membranes was then tested again.

The organic fouling resistance of the membranes was evaluated by the flux recovery rate (FRR=J₁/J₀×100%). The flux decline was measured with both organic foulants as the feed solution (50 mg/L) at a cross-flow velocity of 0.05 m/s.

Results

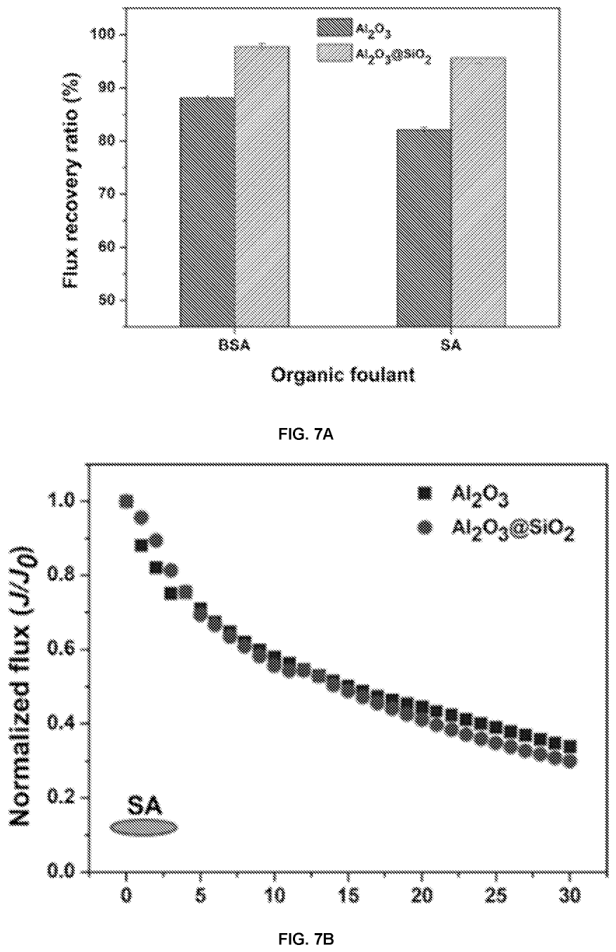

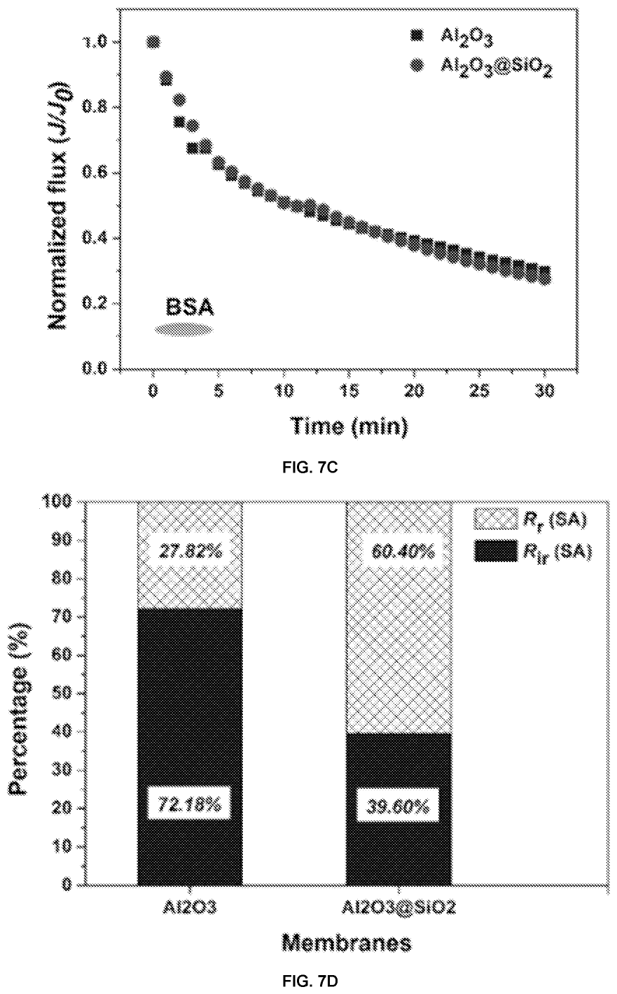

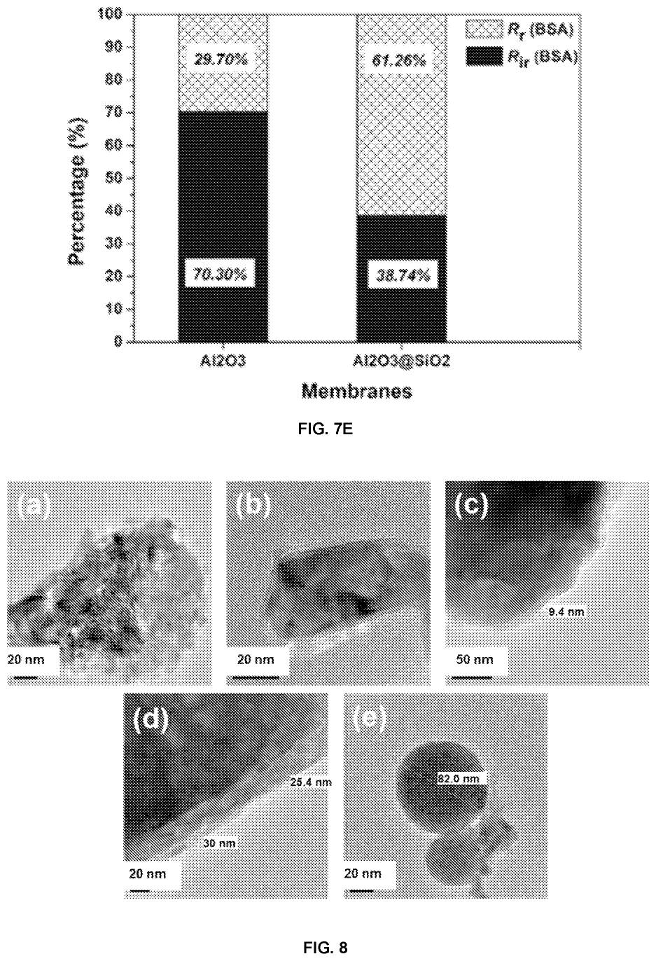

From the above examples, the core-shell structure ceramic membranes comprise of a negatively charged and hydrophilic surface. As shown by FIG. 7A, the surface properties lead to enhanced anti-organic fouling performance. This may be attributed to the electrostatic repulsion effect (between the negatively-charged foulants and negatively-charged membrane surface) and the reduction of hydrophobic interaction.

The anti-organic adsorption property of the membranes was evaluated based on the water flux recovery ratio (FRR) after the static adsorption experiment in BSA and SA solution. As shown in FIG. 7A, the FRR of Al₂O₃©SiO₂ membranes fouled in BSA and SA solution approaches 97.7% and 95.7%, respectively. While in the same condition, the pure Al₂O₃ membranes can only reach the FRR value of 88.1% and 82.1% against BSA and SA, respectively.

BSA is a model foulant of proteins, and SA is a model foulant of polysaccharides. Both BSA and SA are hydrophobic and negatively charged because of the surface phospholipid. The pure Al₂O₃ membranes are hydrophilic, which would to some degree prevent the attachment of hydrophobic BSA and SA, while the positively charged surface of Al₂O₃ membranes would result in the additional attachment of foulants due to the electrostatic attraction. In contrast, the surface of the Al₂O₃©SiO₂ core-shell structure is negatively charged, and the electrostatic repulsion would further prevent the accumulation of the negatively charged foulants (including BSA, and SA) onto the membrane surface. Therefore, the Al₂O₃©SiO₂ core-shell membranes with the negatively-charged and hydrophilic surface are promising anti-fouling ceramic membranes, especially against BSA and SA.

The time-dependent normalized flux (J/J₀) of Al₂O₃ and Al₂O₃©SiO₂ membranes in BSA and SA solution (50 mg/L) with a cross-flow velocity of 0.05 m/s were plotted in FIG. 7B and FIG. 7C. Al₂O₃ and Al₂O₃©SiO₂ membranes show a similar flux decline in BSA and SA solution, respectively, suggesting comparable total resistance (Rₜ). The Rₜ includes the neat membrane resistance (Rₘ) and fouling resistance (R_{f}). The R_{f} comes from the attachment of foulants on the membrane surface and/or in the pore of membranes, which would result in the rapid raise of the filtration resistance. Some of the fouling can be washed away by physical cleaning, corresponding to the reversible fouling resistance (Rᵣ), while others can only be removed by the strongly chemical cleaning, corresponding to the irreversible fouling resistance (Rᵢᵣ). Since membrane fouling is an inevitable issue in the membrane-based separation process, the minimization of the irreversible fouling would greatly ease the regeneration of membranes and minimize the damage to the membrane during the aggressive chemical cleaning. As shown in FIG. 7D and FIG. 7E, the majority of the R_{f} in Al₂O₃ membranes results from the irreversible fouling. For example, the Rₜ of Al₂O₃ membranes in SA solution includes 72.18% of irreversible fouling and 21.82% of reversible fouling. While the construction of core-shell structure membranes can greatly reduce the resistance of irreversible fouling to 39.60%. Similar results were observed in the case of BSA solution, where the irreversible fouling is reduced from 70.30% of Al₂O₃ membranes to 38.74% of Al₂O₃©SiO₂ membranes.

Discussion

The preparation of surface engineered ceramic membranes based on the use of a core-shell structure is a novel strategy. Such a process can be integrated into conventional membrane preparation. Based on the above results, the advantages of ceramic membranes having core-shell structural powders were well-demonstrated. Firstly, the soft SiO₂ layers on the Al₂O₃ surface contributed to their partial sintering at lower temperatures. Secondly, the more hydrophilic SiO₂ shell greatly improved the surface hydrophilicity of ceramic membranes, thereby increasing the permeability. Thirdly, the surface charge was successfully regulated to be negative in a wide pH value by the thin SiO₂ layers, and the organic fouling resistance, specifically the irreversible fouling of ceramic membranes was greatly improved, due to the additional electrostatic repulsive effect. Previously-reported methods that involved surface modification inevitably lead to a reduction in pore-size and require additional steps such as a post-calcination step. In contrast, the currently reported method based on core-shell structured powders can maintain the surface porosity, simplify the process and improve energy-efficiency. The proposed concept of core-shell structure-based separation layer can be extended to prepare other antifouling and functional ceramic membranes by depositing the active materials (such as TiO₂, WO₃, etc.) on the grains of separation layers.

Conclusion

A novel strategy to fabricate the surface engineered ceramic membranes was proposed based on the rationally designed core-shell structure particles. Through the deliberate coating of SiO₂ layers onto the Al₂O₃ particles, anti-fouling ceramic membranes with negatively charged surfaces were successfully fabricated at lowered sintering temperatures. The surface of Al₂O₃ powders was completely covered by the negatively charged SiO₂ layers, and the core-shell structure was strongly negatively charged in wide pH value. Due to the presence of the SiO₂ shell, the Al₂O₃©SiO₂ core-shell structure can be strongly bonded to the substrates at 1150° C., while pure Al₂O₃ powders can only be sintered at a temperature above 1300° C. Compared with pure Al₂O₃ membranes, all the Al₂O₃©SiO₂ membranes showed improved water permeability, i.e. higher pure water flux and reduced membrane resistance, mainly resulting from their improved hydrophilicity. Moreover, the Al₂O₃©SiO₂ membranes showed excellent organic fouling resistance against BSA and SA, specifically with the notable reduction of irreversible fouling, as a result of the hydrophilic and negatively charged membrane surface. It can be concluded that the proposed strategy can not only moderate the processing temperature and simplify the process, but also purposely regulate the surface properties of the ceramic membranes.

### Example 5: The Optimized Procedure for Preparing Al₂O₃©SiO₂ Core-Shell Structured Powders and their Characterization

Al₂O₃©SiO₂ core-shell structured powders were prepared based on the procedure in Example 1 except that a lower amount (from 0.25 to 2 ml) of TEOS precursor was added. In addition, alumina powder from a different source was used.

Experimental

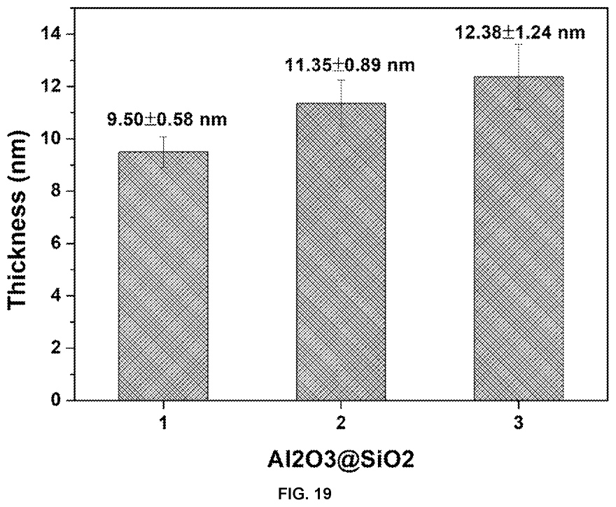

Chemicals including tetraethoxysilane (TEOS, C₈H₂₀O₄Si, 98%, Fluka), sodium hydroxide pellets (NaOH, >97%, Sigma-Aldrich), ethanol (C₂H₅OH, 99%, Sigma-Aldrich) and polyvinyl alcohol (PVA, Mw=72000, Fluka), ammonia solution (NH₄.OH, 28-30%, Merck) were used as received without further purification. α-alumina particles (Sumitomo, Japan) with a mean size of 270 nm (d₅₀=270 nm) were used in preparing the core-shell structured top-layers (see FIG. 19B).

Typically, 1 g of Al₂O₃ powders were dispersed into 40 ml of DI water by ultrasonic treatment (42 kHz, 10 min). Ethanol (34 ml) and ammonia solution (6 ml) were added successively, followed by a continuous stirring at 40° C. for 10 min. The mixture precursor was equally distributed into 4 groups, and different amount of TEOS ethanolic solution (15 vol %) was then drop-wisely added into each suspension. The procedure was repeated with different amounts of TEOS precursor (0.25, 0.5, 1.0 and 2.0 ml) in order to form core-shell particles having a SiO₂ shell of varying thickness. Followed by continuous stirring at room temperature for 12 h, the white precipitates were separated by centrifugation and further washed with DI water, repeatedly, until the pH value reached around 7. After drying at 80° C. for 24 h, the Al₂O₃©SiO₂ core-shell structured powders were ready for characterization and subsequent membrane preparation.

Unless it is provided otherwise, the procedure for each characterization below is the same as those described above in Example 1.

TEM

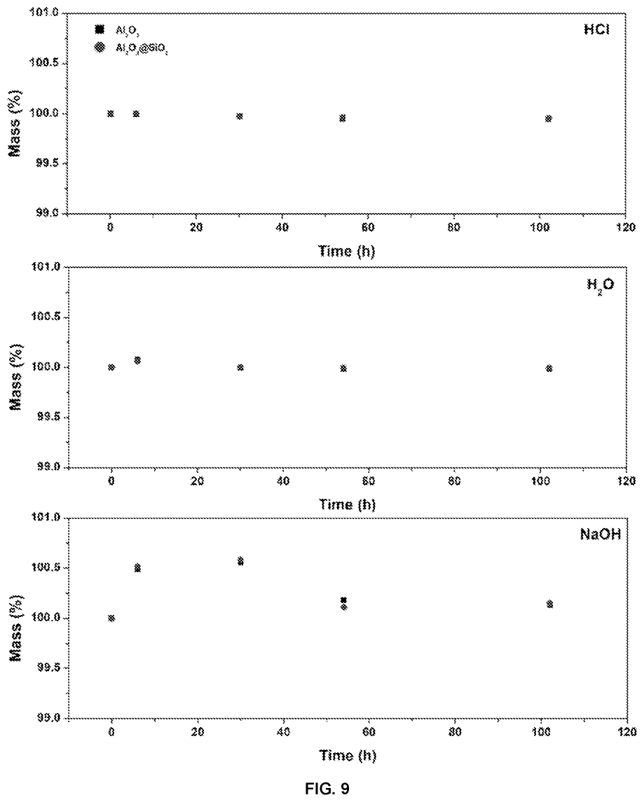

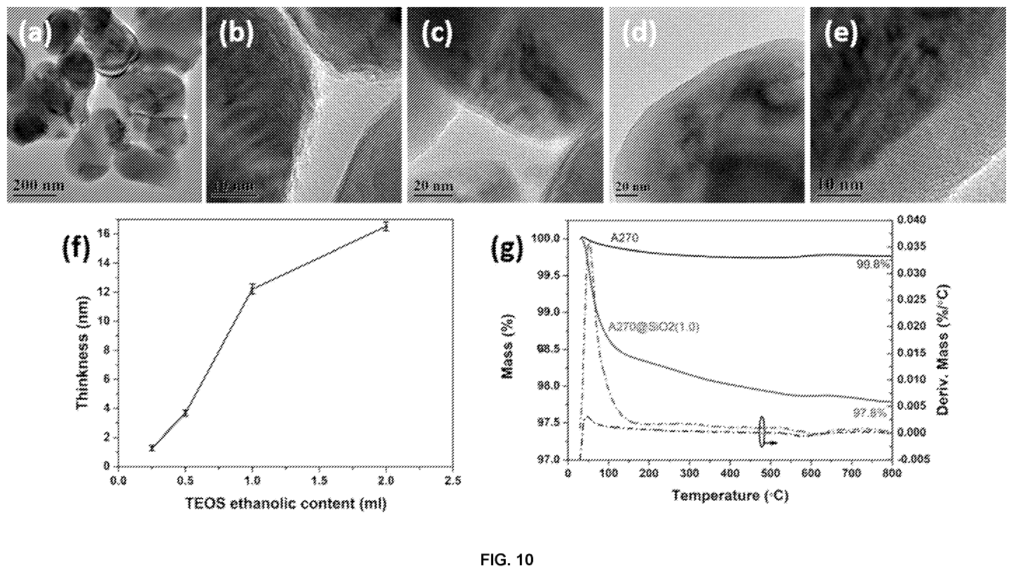

Compared with the pristine alumina particles (x=0; FIG. 10A), a coating layer is observed on the alumina particles prepared with the addition of TEOS solution (x=0.25, 0.50, 1.00 and 2.00), as shown by the TEM images in FIG. 10B to 10E. The thickness can be tuned from several to tens of nanometers by adjusting the content of TEOS content (FIG. 10F).

TGA

From the TGA curves shown in FIG. 10G, the SiO₂ coated alumina powders (X=1.00) present a slight increase in weight loss compared with the pristine alumina powders. This can be explained by the increased amount of surface hydroxyl groups as well as adsorbed surface water molecules.

FTIR

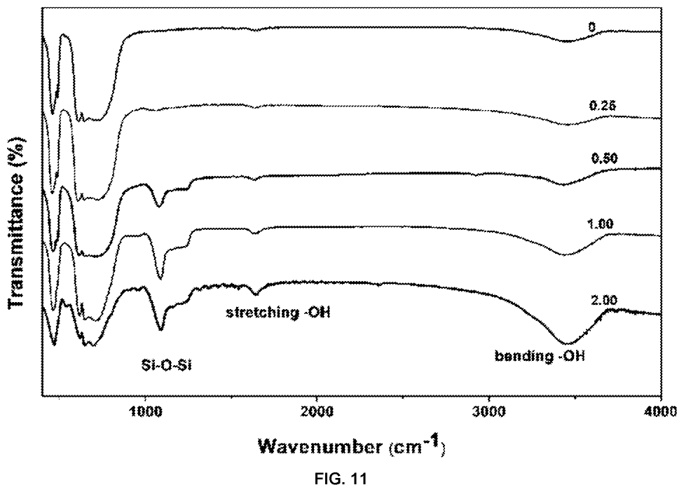

The surface chemistry of the core-shell powders was further studied by FTIR spectra. As shown in FIG. 11, additional peaks at around 1000 cm⁻¹ belonging to Si—O—Si bonds were observed, where the intensity gradually increases with the TEOS content. Also, the peak intensities corresponding to the —OH bending model increases with the TEOS content added in the starting materials, suggesting an increasing amount of hydroxyl groups on the surface. It is known that the hydrophilicity of ceramic powders is closely related to the surface hydroxyl groups. Thus, the coating of the SiO₂ nanoshell on alumina powders would lead to an increase in hydrophilicity of the corresponding membranes.

TEM Mapping

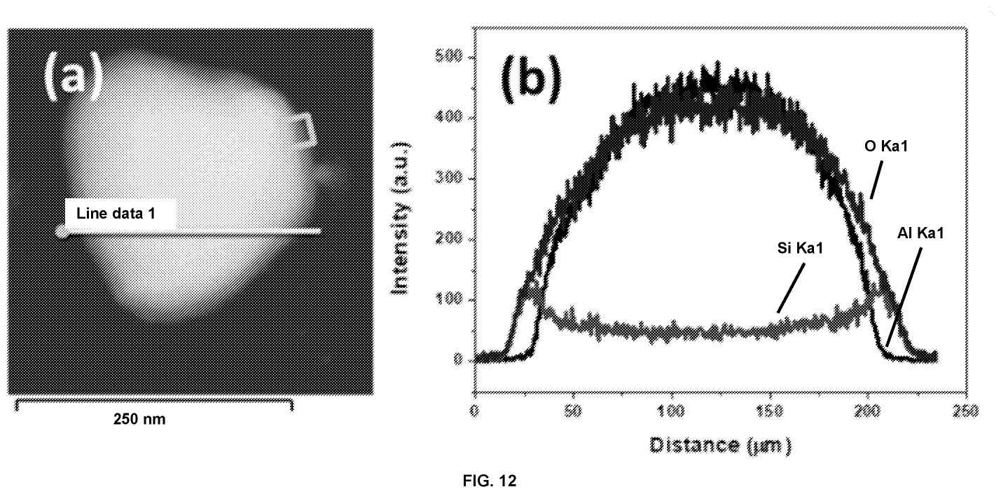

The chemical composition of the core-shell structured particles prepared with 1 ml of TEOS ethanolic solution was further identified by TEM mapping, as shown in FIG. 12.

Elemental analysis was focused on the individual particle, where a thin layer was observed in FIG. 12A. According to the 1D line-scanning, the distribution of the Al element is similar to that of the O element, while the amount of Si element is maximized at the edges (FIG. 12B). Further, the elemental distribution at the edge area was analyzed by elemental mapping, where a clear boundary between the Al and Si can be identified. These results clearly confirm the formation of SiO₂ nanolayer on the surface of alumina particles.

Surface Charge

Surface charge is a vital property of ceramic powders, which determines their dispersive ability in solution and the surface properties of the corresponding bulk sample. The pH value resulting in zero net charges is called the isoelectric point (IEP), which is obtained by means of electrokinetic measurements or the point of zero charges.

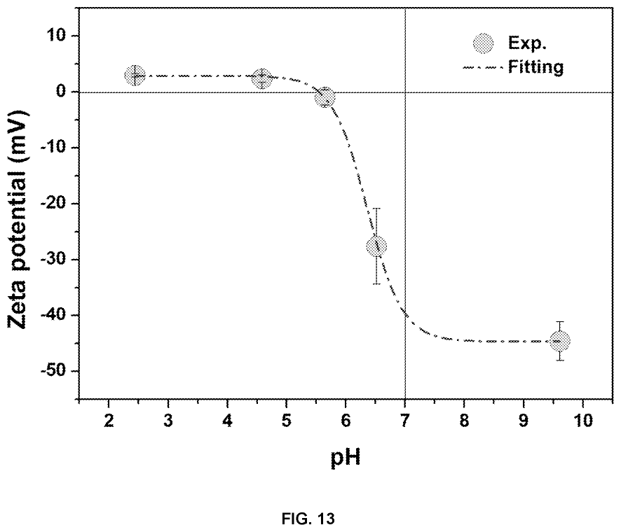

The surface charge of the Al₂O₃©SiO₂ core-shell structured powder particles prepared with 1 ml of TEOS ethanolic solution was measured at different pH values. As shown in FIG. 13, the surface charge of the Al₂O₃©SiO₂ core-shell particles is strongly negative at the pH above 6, and the IEP was determined to be around 5.5. It is known that alumina powders are generally positively charged in a neutral solution with an IEP of ˜9.0. The reduced IEP of the core-shell structured particles is attributed to the formation of SiO₂ nanolayers on the alumina surface, as SiO₂ is known to be negatively charged with an IEP of around 3.2.

### Example 6: Optimized Preparation and Characterization of Core-Shell Ceramic Membranes

Ceramic membranes were prepared by dip-coating the core-shell structured particles as formed from Example 5 onto porous ceramic substrates. For comparison, a set of pure alumina membranes were also prepared under the same condition.

Experimental

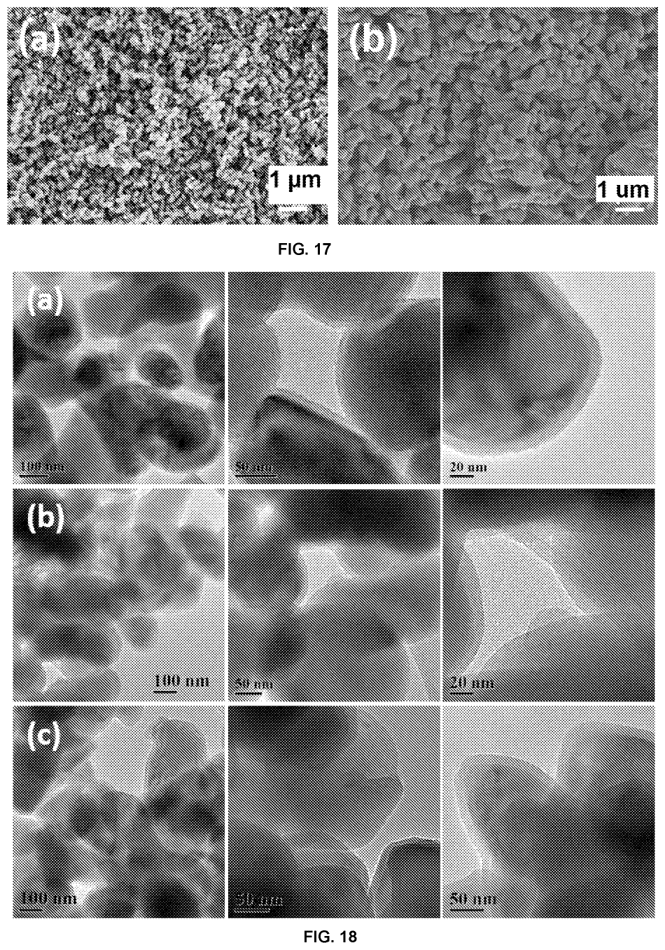

Commercially available flat-sheet alumina ceramic substrates were used as the substrates. The microstructure of the pristine substrate is shown in FIG. 17B.

A homogeneous coating suspension was prepared by using the core-shell particles prepared with 1 ml of TEOS ethanolic solution. The suspension was formulated by the proper amount of ceramic powders (0.5 g), water (2.5 g), PVA solution (10 wt %, 2.5 g) and dispersant (0.4 g). The suspension was then coated onto the porous ceramic substrate (commercial alumina ceramic membranes with an average grain size and an average pore size of 507±172 nm and 310 nm±181 nm, respectively) by dip-coating method. The samples were dried at room temperature for 12 h and then dried at 110° C. for another 12 h. The membranes were then sintered at 1200° C. for 2 h at a ramping rate of 1 C./min to provide membranes with the core-shell structure.

The particle size of alumina powders is smaller than that of the alumina substrate, while slightly larger than the average pore size of alumina substrate, ensures that alumina powders are coated on the surface of alumina substrates, rather than being clogged into the pores of alumina membranes.

The alumina membranes were prepared based on the same procedure except that the Al₂O₃©SiO₂was replaced with Al₂O₃. Unless it is provided otherwise, the procedure for each characterization below is the same as those described above in Example 2.

SEM

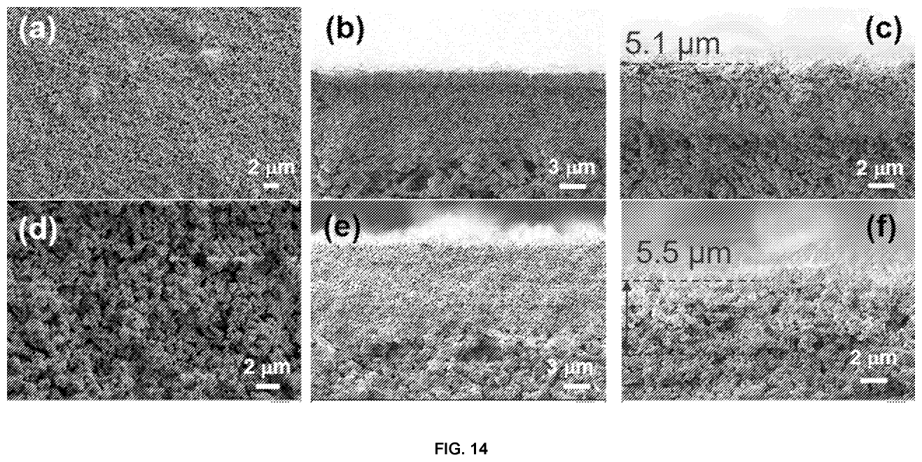

According to the SEM surface images, the membranes with the core-shell structure in FIGS. 14D and 14F show a more porous surface microstructure, compared with the alumina membranes (FIGS. 14A and 14C). As shown in the cross-sectional SEM images in FIG. 14B and FIG. 14E, the ceramic membranes present a typical asymmetric structure comprising of the macro-porous support, intermediate layer and the coated top layer. The thickness of the core-shell layer is determined to be 5.5 μm (see FIG. 14F), which is comparable to that of the alumina membrane (5.1 μm, shown in FIG. 14C). Similar to the alumina membranes, the membranes with the core-shell structure are bonded well with the intermediate layer, and there is no crack or detachment being observed. Compared with the traditional post-modification of ceramic membranes often involving additional processing methods, such as sol-gel surface-coating and atomic layer deposition, the preparation strategy in this work enables the direct formation of surface-modified ceramic membranes. Moreover, through the selection of shell materials, such as a low-melting-point, the preparation process can also be moderated at a relatively lower temperature.

Pore Size

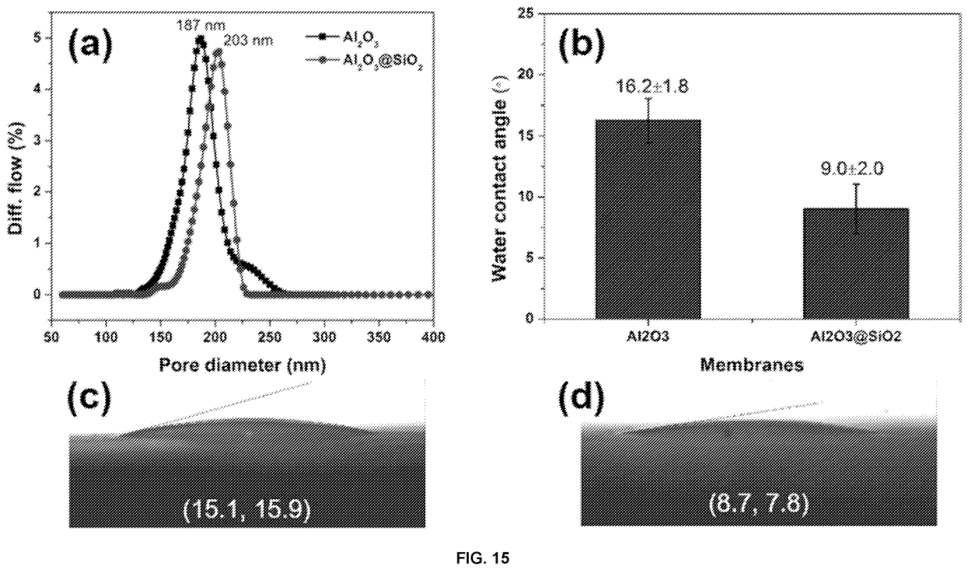

The mean pore size of the core-shell structured membranes (˜203 nm) is slightly larger than that of the pure alumina membranes (˜187 nm), while the pore size distribution of the core-shell structured membranes is significantly narrowed, as shown in FIG. 15A. This can be explained by the slightly increased particle size of the core-shell particles compared with the pristine alumina particles. Generally, the pore size in the membrane layer is correlated to the particle size according to a closely packed structure. In contrast, the use of the traditional post-modification step would inevitably reduce the surface pore size of the pristine ceramic membranes, thereby resulting in a decrease in water permeability.

Water Contact Angle

The water contact angle is an important indicator of surface hydrophilicity. The lower the contact angle value, the higher the hydrophilicity of the membrane would be. The membranes with higher surface hydrophilicity will generally have a greater ability to attract water molecules and at the same time reduce the adsorption of contaminants, which would play a positive role in improving the water flux and antifouling ability. The average water contact angle of the core-shell structured membranes is determined to be 9.0±2.0° (FIG. 15B), which is significantly smaller than that of the alumina membranes without SiO₂ coating layer on the particle surface (16.2±1.8°). The improved hydrophilicity of the core-shell structured membranes is mainly contributed by the superhydrophilic SiO₂ layer. The representative water contact image of the alumina membrane and core-shell structured membranes are shown in FIG. 15C and FIG. 15D, respectively. Therefore, the strategy based on core-shell structured particles provides an effective way to prepare surface modified ceramic membranes with improved permeability.

### Example 7: Permeate Flux and Membrane Resistance

The membranes prepared according to Example 6 were tested for overall permeate flux, which is one of the crucial considerations for the practical application of ceramic membranes, which is affected by membrane resistance and hydrodynamic conditions at the membrane-liquid interface.

The pure water flux (PWF) of the membranes was measured at the TMP of 100 kPa in the dead-end filtration. The procedure for pure water flux and membrane resistance tests is outlined above in Example 3.

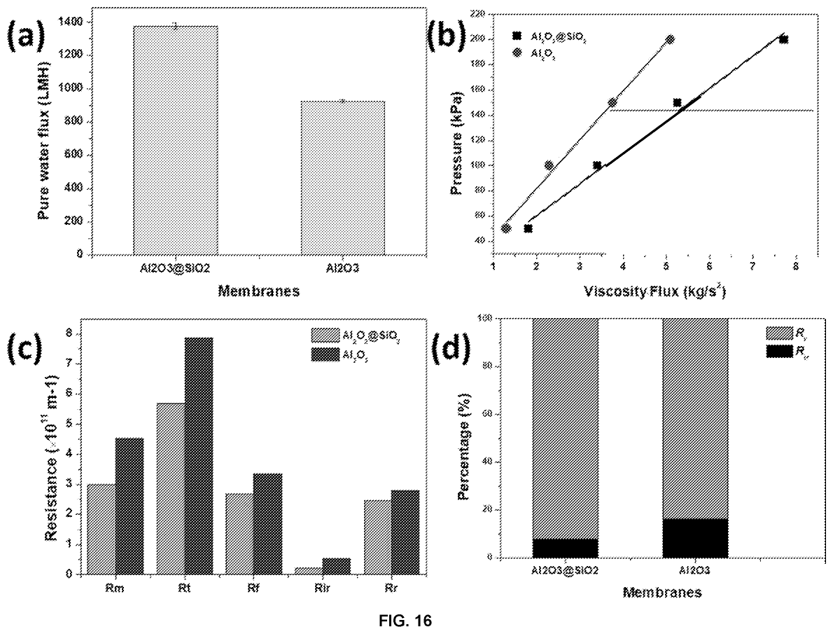

The PWF of the core-shell structured membranes was 1377.3±18.0 LMH, as shown in FIG. 16A, while that of alumina membranes was 927.3±8.0 LMH. The improved PWF of the core-shell membrane is attributed to improved porosity and hydrophilicity. Rₘ was then determined by measuring the PWF at various TMPs. As shown in FIG. 16B, the Rₘ of the core-shell structured membranes is obviously reduced compared with the alumina membrane. It is thus concluded that the core-shell structured membranes show much-improved water permeability, arising from the well-maintained porous structure and improved hydrophilicity.

### Example 8: Fouling Performance

The antifouling properties of the ceramic membranes prepared according to Example 6 were tested using humic acid (HA) solution (50 mg/L) by the cross-flow setup. Filtration conditions were kept constant with a cross-flow velocity of 4 cm/s and an external pressure of 100 kPa supplied by nitrogen gas. The weight of permeate was taken every 30 s for a filtration period of 30 min for flux determination.

After the filtration experiment, the fouling resistances were calculated based on the resistance-in-series model, as shown in Equation: Rₜ=μJ/P=Rₘ+Rᵣ+Rᵢᵣ, where μ is the dynamic viscosity of the pure water (Pa·s), J is the permeate flux (Lm⁻² h⁻¹, LMH), Rₘ is the intrinsic membrane resistance (m⁻¹); Rₜ, Rᵣ and Rᵢᵣ are the total filtration resistance, hydraulically reversible fouling resistance and hydraulically irreversible fouling resistance (m⁻¹), respectively. The fouling resistance (Rₜ) was calculated using Equation: R_{f}=Rₜ−Rₘ. Then, the fouled membrane was cleaned by backwash with pure water at 150 kPa. The filtration resistance of the cleaned membranes (R_{c}) was consequently obtained. Finally, the reversible fouling resistance (R_{f}) and irreversible fouling resistance (Rᵢᵣ) can be calculated using the equations: Rᵣ=Rₜ−R_{c}, and Rᵢᵣ=R_{c}−Rₘ.

Results

Compared with the neat membrane resistance, the total resistance (Rₜ) of both membranes after the filtration of HA solution increases, originating from the adsorption of HA molecules on the membranes. In contrast, the fouling resistance (Rₜ) of the core-shell structured membranes is reduced compared with the alumina membranes, suggesting the improved antifouling properties.

The fouled membranes were subjected to gentle water cleaning, and the membrane resistance of the cleaned membranes (R_{c}) was then measured. The contribution of the irreversible and reversible fouling to the membrane resistance can be identified from equations: Rᵢᵣ=R_{c}−Rₘ and Rᵣ=Rₜ−R_{c}, respectively. As shown in FIG. 16C, the membrane fouling is mainly attributed to reversible fouling, and both reversible and irreversible fouling is lower for the core-shell structured membranes. The percentage of irreversible fouling in the core-shell structured membranes has been reduced by 10% compared with that of the alumina ceramic membranes (FIG. 16D). The much improved anti-organic fouling properties of the core-shell structured membranes are attributed to the improved hydrophilic and negatively charged surface, as most of the organic foulants are known to be hydrophobic and negatively charged. Therefore, compared with the traditional post-modification, the strategy based on core-shell structured particles can successfully engineer the surface properties and at the same time improve the water permeability.

### SUMMARY

Disclosed herein is a novel strategy to prepare ceramic membranes having a modified surface through the use of core-shell structured particles. Hydrophilic and negatively charged SiO₂ nanolayers were successfully coated on the alumina particles, and the core-shell structured particles were then used to form the top layer of ceramic membranes, leading to improvements in permeability and antifouling properties. The surface charge of the core-shell particles was determined to be strongly negative with an IEP of 5.5. The core-shell structured membranes showed improved water permeability, as a result of the increased surface porosity and hydrophilicity. Moreover, the anti-organic fouling property of the core-shell structured membranes was greatly improved, due to the negatively charged membrane surface and improved hydrophilicity. In particular, irreversible fouling was reduced by 10%, which would reduce the maintenance cost.

### Example 9: Preparation of Core-Shell Particles at Fixed TEOS/Al₂O₃ Ratio of 0.6 ml/g with Different Mass Scale

Three samples of core-shell particles were prepared using slightly different procedures involving room temperature reactions as described below, and subsequently characterized by TEM. As shown by the TEM images (FIG. 18) and shell thickness (FIG. 19), the core-shell particles can be prepared at room temperature with good reproducibility and scalability.

Sample 1: Al₂O₃ (1 g) was dispersed into 40 ml of DI water, and the mixture of 34 ml ethanol and 6 ml ammonia solution was then added followed by a continuous stirring at 40° C. for 10 min. After that, 4 ml of TEOS ethanolic solution (15 vol %) was added drop-wise followed by continuous stirring at room temperature overnight.

Sample 2: 1g of Al₂O₃ powders were dispersed into 34 ml of ethanol and 6 ml of ammonia solution followed by a continuous stirring at 40° C. for 10 min. Then, the addition of 4 ml of TEOS ethanolic solution (15 vol %) was added drop-wise followed by continuous stirring at room temperature overnight.

Sample 3: 5 g of Al₂O₃ powders were dispersed into 68 ml of ethanol with the subsequent addition of 12 ml of ammonia solution. After a continuous stirring at 40° C. for 10 min, pure TEOS (3 ml) was drop-wisely added. The mixture was then continuously stirred at room temperature overnight. This can be regarded as a scale-up preparation of Sample 2.

The above samples were then collected by centrifugation at 5000 rpm for 3 min followed by repeated washing with DI water.

1. A ceramic membrane for water and/or wastewater treatment, the membrane comprising:
a ceramic substrate having at least one surface; and
a membrane layer comprising core-shell particles on the at least one surface, where the core is formed from:
an inorganic material with a positive zeta potential; and/or
an inorganic material that has a sintering temperature of from 800 to 2200° C., and the shell is formed from:
an inorganic material having a negative zeta potential; and/or
an inorganic material with a sintering temperature of from 600 to 1400° C., provided that when the core is formed from an inorganic material that has a sintering temperature of 800 to 2200° C. and the shell is formed from an inorganic material with a sintering temperature of from 600 to 1400° C., the sintering temperature of the core is higher than the sintering temperature of the shell.

2. The ceramic membrane according to claim 1, wherein the core of the core-shell particles is formed by one or more metal oxides with a positive zeta potential and/or a sintering temperature of from 800 to 2200° C.

3. The ceramic membrane according to claim 1, wherein the core of the core-shell particles is formed from one or more of the group selected from Al₂O₃ and ZrO₂.

4. The ceramic membrane according to claim 1, wherein the shell of the core-shell particles is formed from one or more of the group selected from SiO₂, TiO₂ and WO₃.

5. The ceramic membrane according to claim 4, wherein the shell of the core-shell particles is formed from SiO₂.

6. The ceramic membrane according to claim 1, wherein the shell of the core-shell particles has an average thickness of from 1 to 50 nm.

7. The ceramic membrane according to claim 1, wherein the core-shell particles have an average size of from 50 nm to 20 μm, such as from 100 to 500 nm.

8. The ceramic membrane according to claim 1, wherein the membrane layer has a thickness of from 3 to 50 μm.

9. The ceramic membrane according to claim 1, wherein the membrane layer has a zeta potential of from −10 mV to −50 mV, such as from 20 to 30 mV, when measured in a medium having a pH of from 6 to 8.

10. The ceramic membrane according to claim 1, wherein:
(a) the ceramic membrane has a pure water flux of from 800 to 2500 LMH when measured using a trans-membrane pressure of 100 kPa; and/or
(b) the water flux recovery ratio is greater than 70%; and/or
(c) the irreversible fouling of the ceramic membrane exposed to BSA and/or SA is less than 50%; and/or
(d) the membrane has an average water contact angle of from 6° to 12° and/or
(e) the membrane has a mean pore size of from 60 to 250 nm.

11. A core-shell particle comprising:
a core formed from:
an inorganic material with a positive zeta potential; and/or
an inorganic material that has a sintering temperature of 800 to 2200° C.; and
a shell formed from:
an inorganic material having a negative zeta potential; and/or
an inorganic material with a sintering temperature of from 600 to 1400° C., wherein the core-shell particles have a zeta potential of from −10 mV to −50 mV when measured in a medium having a pH of from 6 to 8, provided that when the core is formed from an inorganic material that has a sintering temperature of 800 to 2200° C. and the shell is formed from an inorganic material with a sintering temperature of from 600 to 1400° C., the sintering temperature of the core is higher than the sintering temperature of the shell.

12. The core-shell particle according to claim 11, wherein the core is formed from a metal oxide.

13. The core-shell particle according to claim 11, wherein the shell is formed from one or more of the group selected from SiO₂, TiO₂ and WO₃.

14. The core-shell particle according to claim 11, wherein the shell of the core-shell particles has an average thickness of from 1 to 50 nm.

15. The core-shell particle according to claim 11, wherein the core-shell particles have an average size of from 50 nm to 20 μm.

16. A method of using a ceramic membrane for water and/or wastewater treatment as described in claim 1, which method comprises the steps of treating water or wastewater in a treatment system fitted with said ceramic membrane.

17. A method of manufacturing a ceramic membrane for water and/or wastewater treatment as described in claim 1, comprising the steps of:
(i) providing a pre-sintered ceramic membrane comprising:
a ceramic substrate having at least one surface; and
a layer on the at least one surface comprising core-shell particles as described in claim 11 and one or more polymeric additives; and
(ii) sintering the pre-sintered ceramic membrane at a suitable temperature for a period of time to remove the polymeric additives and provide the ceramic membrane.

18. The method according to claim 17, wherein the pre-sintered ceramic membrane is formed by providing a ceramic substrate having at least one surface and coating the at least one surface with a mixture comprising one or more polymers and core-shell particles as described in claim 11.
